(19) United States
(12) Patent Application Publication
(10) Pub. No.: US 2026/0032577 A1
(43) Pub. Date: Jan. 29, 2026

(54) SERVICE CONTINUITY FOR MULTICAST TRANSMISSION FOR CELL RESELECTION

(71) Applicant: Apple Inc., Cupertino, CA (US)

(72) Inventors: Fangli Xu, Beijing (CN); Haijing Hu, Los Gatos, CA (US); Naveen Kumar R. Palle Venkata, San Diego, CA (US); Dawei Zhang, Saratoga, CA (US); Yuqin Chen, Beijing (CN); Chunhai Yao, Beijing (CN); Pavan Nuggehalli, San Carlos, CA (US); Ralf Rossbach, Munich (DE); Alexander Sirotkin, Tel Aviv (IL)

(73) Assignee: Apple Inc., Cupertino, CA (US)

(21) Appl. No.: 18/996,946

(22) PCT Filed: Jul. 22, 2022
(86) PCT No.: PCT/CN2022/107432

§ 371 Date: Jan. 17, 2025

(51) Int. Cl. H04W 48/20; H04W 76/20; H04W 76/30; H04W 76/40

(52) U.S. Cl. CPC H04W 48/20; H04W 76/20; H04W 76/30; H04W 76/40

(57) ABSTRACT

The present application relates to devices and components including apparatus, systems, and methods to provide processing of multicast data via user equipment while the user equipment is in an inactive state in wireless communication systems.

### BACKGROUND

Third Generation Partnership Project (3GPP) networks provide that for multicast transmissions between base stations and user equipment (UE). In particular, a base station may multicast transmissions to a plurality of UEs. The UEs may be in a connected state with the base station to receive the multicast transmissions from the base station. This can allow the base station to communicate data to multiple UEs at a same time.

### BRIEF DESCRIPTION OF THE DRAWINGS

FIG. 1 illustrates an example network arrangement in accordance with some embodiments.

FIG. 2 illustrates an example network arrangement in accordance with some embodiments.

FIG. 3 illustrates an example signaling chart showing lossless reconfiguration in accordance with some embodiments.

FIG. 4 illustrates an example cell selection arrangement with a single cell list in accordance with some embodiments.

FIG. 5 illustrates an example cell selection arrangement with a single cell list in accordance with some embodiments.

FIG. 6 illustrates an example cell selection arrangement with frequency lists in accordance with some embodiments.

FIG. 7 illustrates an example cell selection arrangement with frequency lists in accordance with some embodiments.

FIG. 8 illustrates an example cell selection arrangement with cell lists in accordance with some embodiments.

FIG. 9 illustrates an example cell selection arrangement with cell lists in accordance with some embodiments.

FIG. 10 illustrates an example cell selection arrangement with a frequency/cell list in accordance with some embodiments.

FIG. 11 illustrates an example procedure for determining resources for multicast transmissions in accordance with some embodiments.

FIG. 12 illustrates another example procedure for determining resources for multicast transmissions in accordance with some embodiments.

FIG. 13 illustrates an example procedure for indicating resources for multicast transmissions in accordance with some embodiments.

FIG. 14 illustrates an example user equipment (UE) in accordance with some embodiments.

FIG. 15 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

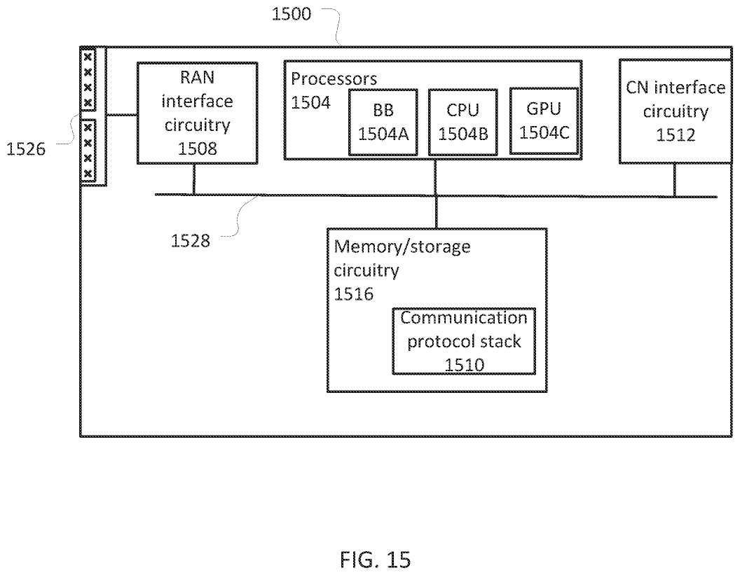

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like. In embodiments, the term “network element” may refer to base station, a nodeB, an evolved nodeB (eNB), and/or a next generation (gNB) (such as the gNB 1500 (FIG. 15)).

The term “information element” refers to a structural element containing one or more fields. The term “field” refers to individual contents of an information element, or a data element that contains content. An information element may include one or more additional information elements.

The disclosure refers to the states of the “connected state” and the “inactive state.” These states are well known in the art and should be interpreted as known in the art. For example, each of the “connected state” and the “inactive state” may each present at least some different features from the other states and/or may present different connections from the other states.

### MBS Enhancement

### Justification

To enable resource-efficient delivery of multicast/broadcast services, third generation partnership project (3GPP) has developed new radio (NR) broadcast/multicast in release 17 (Rel-17) according to the work item description (WID) in RP-201038, aiming to enable general multicast/broadcast service (MBS) services over fifth generation system (5GS). The use cases identified that could benefit from this feature include public safety and mission critical, vehicle to everything (V2X) applications, internet protocol television (IPTV), live video, software delivery over wireless and internet of things (IoT) applications, etc. Two delivery modes have been agreed for Rel-17 MBS with delivery mode 1 (only for multicast) capable of addressing higher quality of service (QoS) services and delivery mode 2 (only for broadcast) focusing on lower QoS services. Given that Rel-17 MBS already provide the basic function to support MBS services, the general main goal for release 18 (Rel-18) should be to enable better deployment of MBS, such as improvement of resource efficiency and capacity based on Rel-17 MBS.

In Rel-17, radio access network (RAN) only specifies multicast for user equipments (UEs) in RRC_CONNECTED state, which may not fully fulfil the requirements of, e.g., Mission Critical Services, especially for cells with a large number of UEs according to TR 23.774. Also, to always keep UEs in RRC_CONNECTED state is not power efficient. It is therefore important to support multicast for UEs in RRC_INACTIVE.

The Rel-17 new radio (NR) MBS broadcast solution allows that the UE receives broadcast service in a downlink only manner i.e. performing broadcast reception without a need to access the network beforehand. However, in the typical use case for broadcast, the UE may be required to simultaneously receive broadcast service and unicast service from the network(s) of same or another operator, and some UEs may share the hardware resources between broadcast and unicast. Therefore, the unicast connection might be impacted by the broadcast reception for this kind of UEs. The optimization for such case is not specifically addressed in Rel-17, and should focus on the case of unicast reception in RRC_CONNECTED and broadcast reception from the same or different operators, including emergency and public safety broadcast.

Network sharing is a common practice to reduce network capital expenditure (CAPEX). With RAN sharing deployment, if the same Multicast/Broadcast service is provided by two (or more) operators separately, this service would be recognized as separate temporary mobile group identities (TMGIs) resulting in duplicated point to multipoint (PTM) radio resources consumption in the same cell for transmission of the same content. This justifies resource efficiency improvement in the RAN sharing scenario.

Note that public safety services benefit from the Rel-17 NR MBS functions, as well as from Rel-18 enhancements that follow the above justifications.

### Objective

Objective of system information (SI) or Core part work item (WI) or Testing part WI.

This Work Item is to further enhance the NR Multicast/Broadcast functions based on Rel-17 MBS. The objectives for Rel-18 include specify support of multicast reception by UEs in RRC_INACTIVE state [radio access network group 2 (RAN2), radio access network group 3 (RAN3)]. PTM configuration for UEs receiving multicast in RRC_INACTIVE state [RAN2], and study the impact of mobility and state transition for UEs receiving multicast in RRC_INACTIVE (Seamless/lossless mobility is not required) [RAN2, RAN3]. The objectives further include specify Uu signalling enhancements to allow a UE to use shared processing for MBS broadcast and unicast reception, i.e., including UE capability and related assistance information reporting regarding simultaneous unicast reception in RRC_CONNECTED and MBS broadcast reception from the same or different operators [RAN2], and study and, if necessary, specify enhancements to improve the resource efficiency for MBS reception in RAN sharing scenarios [RAN3]. Note: collaboration with system aspects working group 2 (SA2) is expected in due course for the above objectives.

### Issue Statement

Multicast service continuity in release 17 (R17). The multicast transmission is only supported for the connected UE. For the handover between the multicast supporting next generation NodeBs (gNBs), service continuity and lossless handover for the multicast MBS are supported during the handover. For lossless handover, it is supported for the point-to-point (PTP) to PTP or PTP to PTP+point-to-multipoint (PTM) case. For service continuity, network (NW) can provide the MBS multicast service continuity during the handover. For example, the downlink (DL) packet data convergence protocol (PDCP) sequence number (SN) synchronization and continuity between source and target cell is supported. The source gNB may forward the data from source gNB to the target gNB in order for lossless handover or minimize the interruption. UE can provide the PDCP status report for the MBS radio bearer (MRB) in the target cell, and NW can retransmit the lossless packet based on it.

For the handover between the multicast support gNB to the non-supporting gNB, core network (CN) can switch the MRB to dedicated radio bearer (DRB) and continually provide the MBS service over the radio bearer. In release 18 (R18), service continuity will be supported for the multicast MBS transmission in INACTIVE state, and some enhancements need to be considered.

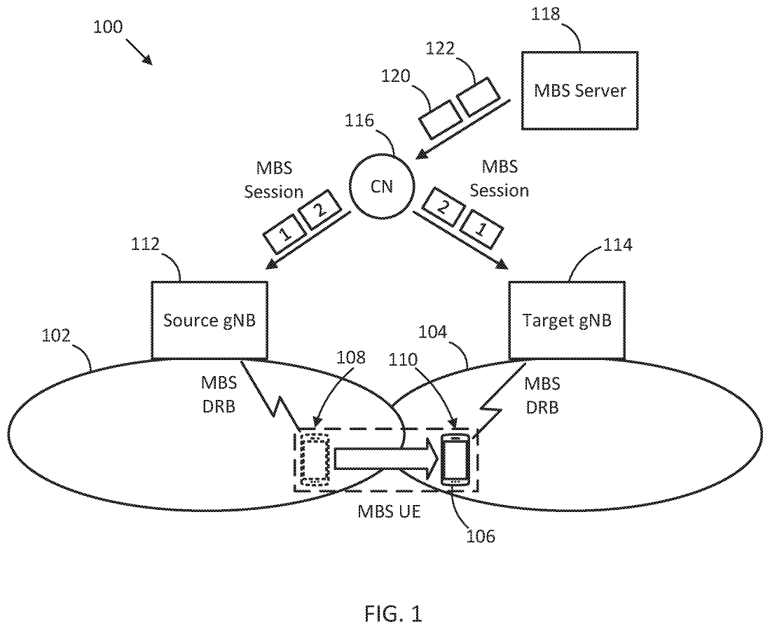

FIG. 1 illustrates an example network arrangement 100 in accordance with some embodiments. The network arrangement 100 illustrates an example UE handover from a first cell 102 that supports MBS data resource bearers (DRBs) to a second cell 104 that supports MBS DRBs.

The network arrangement 100 may include a UE 106. The UE 106 may have moved from a first position 108 (as indicated by a dotted lines version of the UE 106 shown at the first position 108) within the first cell 102 to a second position 110 within the second cell 104.

The network arrangement 100 may include a source base station 112 and a target base station 114 (both illustrated as gNBs in the illustrated embodiment). The source base station 112 may provide services for the first cell 102, where the source base station 112 may provide services to UEs located within the first cell 102. The target base station 114 may provide services for the second cell 104, where the target base station 114 may provide services to UEs located within the second cell 104. As the UE 106 moves from the first position 108 within the first cell 102 to the second position 110 within the second cell 104, a handover may be performed to hand service of the UE 106 over from the source base station 112 to the target base station 114.

The network arrangement 100 may include a CN 116. The CN 116 may be coupled to both the source base station 112 and the target base station 114. The source base station 112 and the target base station 114 may both communicate with the CN 116 to provide services.

The network arrangement 100 may include an MBS server 118. The MBS server 118 may be coupled to the CN 116. The MBS server 118 may provide an MBS session to be distributed by the CN 116, the MBS session represented by a first MBS packet 120 and a second MBS packet 122. The CN 116 may provide the first MBS packet 120 and the second MBS packet 122 to both the source base station 112 and the target base station 114. The first MBS packet 120 transmitted to both the source base station 112 and the target base station 114 may have the same SN. Further, the second MBS packet 122 transmitted to both the source base station 112 and the target base station 114 may have the same SN.

As the source base station 112 supports MBS DRBs, the UE 106 may receive the multicast data via multicast transmission when located at the first position 108. As the target base station 114 supports MBS DRBs, the UE 106 may continue to receive the multicast data via multicast transmission when located at the second position 110. Accordingly, the UE 106 may receive the multicast data via multicast transmission from the source base station 112 prior to the handover and may receive the multicast data via multicast transmission from the target base station 114 after the handover. The handover between the source base station 112 and the target base station 114 may be supported for the UE 106 being in the connected state and may provide the features for handover between multicast supporting gNBs described above.

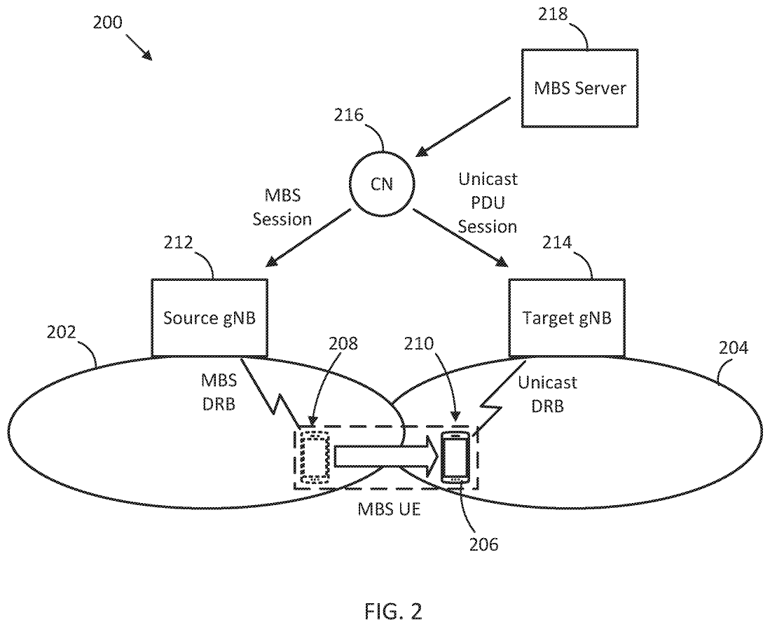

FIG. 2 illustrates an example network arrangement 200 in accordance with some embodiments. The network arrangement 200 illustrates an example UE handover from a first cell 202 that supports MBS data resource bearers (DRBs) to a second cell 204 that does not support MBS DRBs.

The network arrangement 200 may include a UE 206. The UE 206 may have moved from a first position 208 (as indicated by a dotted lines version of the UE 206 shown at the first position 208) within the first cell 202 to a second position 210 within the second cell 204.

The network arrangement 200 may include a source base station 212 and a target base station 214 (both illustrated as gNBs in the illustrated embodiment). The source base station 212 may provide services for the first cell 202, where the source base station 212 may provide services to UEs located within the first cell 202. The target base station 214 may provide services for the second cell 204, where the target base station 214 may provide services to UEs located within the second cell 204. As the UE 206 moves from the first position 208 within the first cell 202 to the second position 210 within the second cell 204, a handover may be performed to hand service of the UE 206 over from the source base station 212 to the target base station 214.

The network arrangement 200 may include a CN 216. The CN 216 may be coupled to both the source base station 212 and the target base station 214. The source base station 212 and the target base station 214 may both communicate with the CN 216 to provide services.

The network arrangement 200 may include an MBS server 218. The MBS server 218 may be coupled to the CN 216. The MBS server 218 may provide an MBS session to be distributed by the CN 216. The CN 216 may provide the MBS session to the source base station 212, where the source base station 212 supports MBS DRBs and can provide MBS session via multicast transmissions. In contrast, the target base station 214 may not support MBS DRBs and may support unicast DRB instead. The CN 216 may provide the MBS session received from the MBS as a unicast protocol data unit (PDU) session to the target base station 214 based on the target base station 214 supporting unicast DRB

As the source base station 212 supports MBS DRBs, the UE 206 may receive the multicast data via multicast transmission when located at the first position 208. As the target base station 214 does not support MBS DRBs and supports unicast DRBs, the UE 206 may receive the unicast PDU data via DRB when located at the second position 210. Accordingly, the UE 206 may receive the multicast data via multicast transmission from the source base station 212 prior to the handover and may receive the unicast PDU data via DRB from the target base station 214 after the handover. The handover between the source base station 212 and the target base station 214 may be supported for the UE 106 being in the connected state and may provide the features for handover between multicast supporting gNB and a multicast non-supporting gNB as described above.

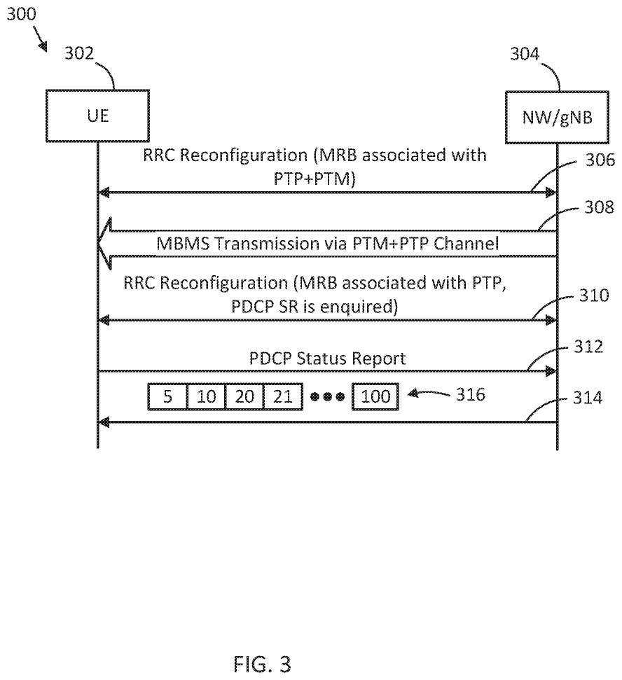

FIG. 3 illustrates an example signaling chart 300 showing lossless reconfiguration in accordance with some embodiments. For example, the signaling chart 300 illustrates signals that may be exchanged to facilitate lossless reconfiguration.

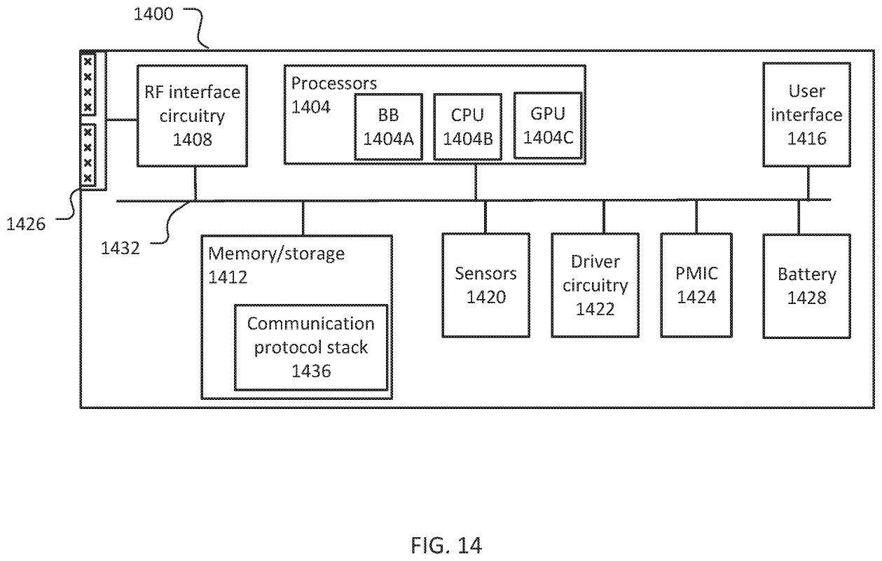

The signaling chart 300 may include a UE 302 and a network element 304. The UE 302 may include one or more features of the UE 1400 (FIG. 14). The network element 304 may include one or more features of the gNB 1500 (FIG. 15). The signaling chart 300 illustrates signals that may be exchanged between the UE 302 and the network element 304 for lossless reconfiguration of the UE 302.

The signaling chart 300 may initiate with a RRC reconfiguration 306 of the UE 302. In particular, the UE 302 and the network element 304 may exchange one or more signals to reconfigure the RRC of the UE 302. The RRC reconfiguration 306 in the illustrated embodiment may reconfigure the UE 302 for MRB associated with PTP and PTM. Accordingly, the UE 302 may be reconfigured with configuration for MRB associated PTP and PTM in the illustrated embodiment.

Once the UE 302 has been configured by the RRC reconfiguration 306, the network element may transmit one or more MBS transmissions 308 to the UE 302 via a PTM channel and a PTP channel. The UE 302 may receive the MBS transmissions 308 and process the MBS transmissions 308 using the configuration indicated by the RRC reconfiguration 306. In some instances, one or more PDCP PDUs and/or service data units (SDUs) provided within the MBS transmissions 308 may not be properly received and/or processed by the UE 302.

Another RRC reconfiguration 310 may be performed between the UE 302 and the network element 304. For example, one or more signals may be exchanged between the UE 302 and the network element 304 for the RRC reconfiguration 310 to reconfigure the UE 302 with a new configuration. The RRC reconfiguration 310 may indicate a configuration of MRB with PTP in the illustrated embodiment. The RRC reconfiguration 310 may further include an indication of a PDCP status report (SR) enquiry for the UE 302. For example, the RRC reconfiguration 310 may request that the UE provide a PDCP status report.

The UE 302 may transmit a PDCP status report 312 to the network element 304. The UE 302 may transmit the PDCP status report 312 in response to the RRC reconfiguration 310. The PDCP status report 312 may indicate SNs for PDUs and/or SDUs properly received and processed by the UE 302. The PDCP status report 312 may be for the MRB. In the illustrated embodiment, the PDCP may receive and properly process PDUs and/or SDUs with SNs 6-9 and 11-19. The properly processed PDUs and/or SDUs may be stored by the UE 302. The PDCP status report 312 may indicate the SNs for the PDUs and/or the SDUs stored by the UE 302 and/or the SNs for PDUs and/or SDUs that the UE 302 determined were not properly received.

The network clement 304 may transmit additional MBS transmissions 314 to the UE 302 via PTP. The MBS transmissions 314 may include PDUs and/or SDUs that were not previously properly processed by the UE 302. For example, the network element 304 may determine that the UE 302 did not properly process a PDU or SDU corresponding to SN 5 and a PDU or SDU corresponding to SN 10 based on the PDCP status report 312. The network element 304 may retransmit the PDU or SDU corresponding to SN 5 and the PDU or SDU corresponding to SN 10 in the MBS transmissions 314. In particular, the MBS transmissions 314 may include PDUs and/or SDUs 316. As can be seen the PDUs and/or SDUs 316 of the MBS transmissions 314 include the PDU or the SDU corresponding to SN 5 and the PDU or the SDU corresponding to SN 10. Upon receiving the SN 5 and the SN 10, the UE may deliver all previously stored PDCP SDUs and/or PDUs to an upper layer.

### Approach: Service Continuity During the Inactive Mobility

Network (NW) can provide the cell list/frequency list where NW can provide the INACTIVE multicast service to UE via dedicated or broadcast signaling. For example, the NE may provide a cell list and/or a frequency list where the NW can provide multicast service to a UE via dedicated signaling or broadcast signaling where the UE is in the inactive state. The cells in the cell list and/or the frequencies within the frequency list may be referred to as resources. The resources can be provided by the network.

Optionally, NW can provide to UE the cell list which is only associated to the UE joint multicast MBS session. For example, the NW can provide a cell list to the UE, where the cell list may be associated with PTP and PTM links. Signaling format: the dedicated signaling is via the RRCRelease message; the broadcast signaling is via the multicast related system information block (SIB) and multicast/broadcast service control channel (MCCH) configuration. For example, the signaling format for dedicated signaling may be via RRCRelease messaging. The signaling format for broadcast signaling may be via the multicast related SIB and MCCH configuration.

Cell/frequency list configuration: option 1: the cells in the list provide the multicast service; option 2: multiple cell/frequency list, one per multicast MBS session; option 3: two cell/frequency list, one for the multicast service provided in CONNECTED state, the other for the multicast service provided in INACTIVE state; and option 4: combined option 2 and option 3, i.e provide the cell/frequency list per multicast MBS session per RRC state.

For example, the cell and/or frequency list may have multiple options for configuration. In a first option, the NW may provide a list of cells to provide the multicast service. In particular, the cells in the list of cells may be able to provide multicast service to the UE. In this option, the list of cells may not differentiate between which MBS session is provided by which cell in the list.

In a second option, the NW may provide one or more lists of one or more resources to provide the multicast service. The resources within the lists may be cells in some embodiments and frequencies in other embodiments. Each of the lists may correspond to a multicast MBS session. For example, a first list of resources may correspond to a first multicast MBS session and a second list of resources may correspond to a second multicast MBS session.

In a third option, the NW may provide two lists of one or more resources to provide the multicast service. The resources within the lists may be cells in some embodiments and frequencies in other embodiments. A first list of the resources may indicate resources that are for multicast service provided when the UE is in a connected state. A second list of the resources may indicate resources that are for multicast service provided when the UE is in an inactive state.

A fourth option may combine the second option and the third option. For example, the NW may provide one or more lists of one or more resources to provide the multicast service. The resources within the lists may be cells in some embodiments and frequencies in other embodiments. Each of the lists may correspond to a multicast MBS session and an RRC state.

UE operation. UE can prioritize to camp on the cell in the list: 1) when the MBS session is activated; or 2) when UE has joint at least one MBS session regardless of the RRC state. If the list is provided per MBS session, UE can prioritize the cell in the list associated to its joint MBS session. If the list is provided per RRC state, UE can provide the cell in the list associated to the RRC state according to the following rules: 1) NW indicates which RRC state has the higher priority, OR 2) Up to UE implementation, OR 3) predefine which RRC state has the high priority.

During the cell reselection, if UE cannot find the suitable cell in the list, UE will camp on the suitable cell and trigger the RRCResume procedure and request entering the CONNECTED state.

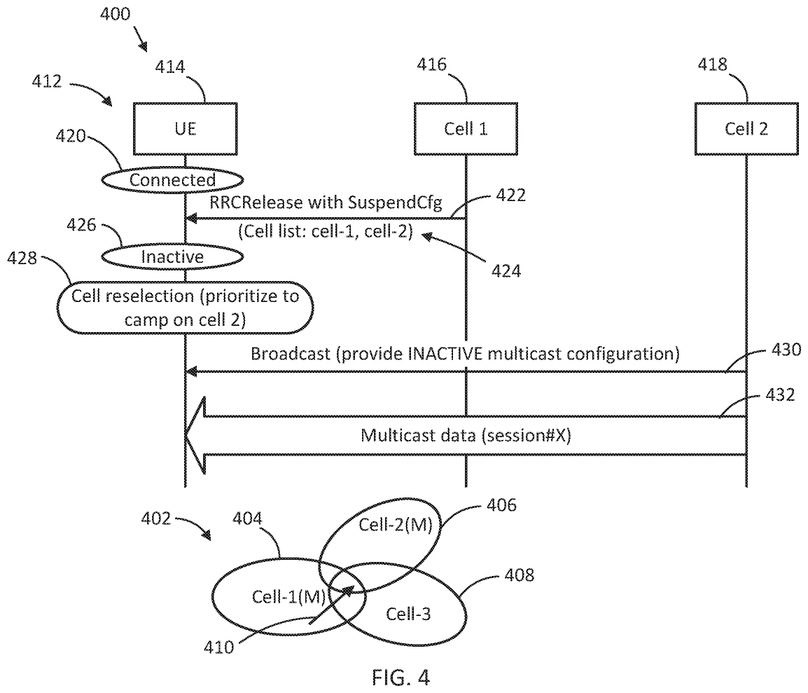

Example 1: One cell/frequency list. NW only provide one cell/frequency list to indicate the cell supporting inactive multicast service. For example, the network may provide a cell list or a frequency list to indicate one or more cells supporting multicast service while a UE is in an inactive state. FIG. 4 illustrates an example cell selection arrangement 400 with a single cell list in accordance with some embodiments. In particular, the cell selection arrangement 400 illustrates an example of option 1 where the network may provide a list of cells to indicates cells that support inactive multicast service. In other embodiments, the list of cells may be replaced by a list of frequencies, where the list of frequencies may replace the list of cells in the operation throughout this description.

The cell selection arrangement 400 illustrates an example positional arrangement 402 and an example signaling chart 412 for cell selection with a single cell list. The positional arrangement 402 in the illustrated embodiment indicates a first cell area 404, a second cell area 406, and a third cell area 408. The first cell area 404 indicates an area that can be serviced by a first cell, the second cell area 406 indicates an area that can be serviced by a second cell, and the third cell area 408 indicates an area that can be service by a third cell.

The positional arrangement 402 further illustrates an arrow 410 that indicates movement of a UE in the area. As can be seen by the arrow 410, the UE starts within the first cell area 404. The UE moves from the first cell area 404 to an area within the first cell area 404, the second cell area 406, and the third cell area 408 as indicated by the arrow 410. Based on the movement of the UE indicated by the arrow 410, the UE may determine that a reselection is to be performed from being serviced by the first cell to being serviced by another cell based on the movement toward the edge of the first cell area 404.

The signaling chart 412 may include a UE 414, a first network element 416 corresponding to a first cell, and a second network element 418 corresponding to a second cell. The UE 414 may correspond to the UE illustrated by the arrow 410 in the positional arrangement 402. The first cell of the first network element 416 may correspond to the first cell area 404, where the first cell provides service to the first cell area 404. The second cell of the second network element 418 may correspond to the second cell area 406, where the second cell provides service to the second cell area 406. The UE 414 may include one or more of the features of the UE 1400 (FIG. 14). The first network element 416 and the second network element 418 may each include one or more of the features of the gNB 1500 (FIG. 15).

At the initiation of the signaling chart 412, the UE 414 may be in a connected state, as indicated by connected 420. In particular, the UE 414 may be connected to the first network element 416 based on the UE 414 being located within the first cell area 404 at the initiation of the signaling chart 412.

The first network element 416 may transmit an RRC release with suspend configuration message 422 to the UE 414 to cause the UE 414 to transition to an inactive state. The first network element 416 may transmit the RRC release with suspend configuration message 422 based on the UE 414 moving toward an edge of the first cell area 404 in some embodiments. In some embodiments, the first network element 416 may transmit the RRC release with suspend configuration message 422 based on conditions for transitioning the UE 414 to the inactive state being met, such as there being a lack of transmissions to be transmitted between the UE 414 and the first network element 416.

The RRC release with suspend configuration message 422 may include a cell list 424 that indicates one or more cells. The cell list 424 may indicate one or more cells that can provide multicast service to the UE 414 while the UE 414 is in an inactive state. In the illustrated example, the cell list 424 indicates that the first cell and the second cell can provide multicast service to the UE 414 while the UE 414 is in the inactive state.

The UE 414 may receive the RRC release with suspend configuration message 422 and identify the RRC release with suspend configuration message 422. The UE 414 may further identify the cell list 424 of the RRC release with suspend configuration message 422. The UE 414 may determine which cells and/or network elements can provide multicast service to the UE 414 while the UE 414 is in the inactive state. In the illustrated example, the UE 414 may determine that the first cell (which is serviced by the first network element 416) and the second cell (which is serviced by the second network element 418) can provide multicast service to the UE 414 when the UE 414 is in the inactive state based on the cell list 424. The UE 414 may store the indication of the first cell and the second cell as being able to provide multicast service to the UE 414 when the UE 414 is in the inactive state to be utilized for selecting a cell on which to camp in subsequent cell reselections.

The UE 414 may determine that the UE 414 is to transition to the inactive state based on the RRC release with suspend configuration message 422. The UE 414 may transition to the inactive state, as indicated by inactive 426.

The UE 414 may perform a cell reselection procedure 428 while in the inactive state. The UE 414 may perform the cell reselection procedure 428 based on a condition for cell reselection being met, such as a quality of service provided by a current cell and/or signal strength of signals provided by the current cell falling below a threshold level. In the illustrated example, the UE 414 may perform the cell reselection procedure 428 when the UE 414 is located in the area located within the first cell area 404, the second cell area 406, and the third cell arca 408.

The UE 414 may utilize the information from the cell list 424 to select a cell on which to camp. For example, the UE 414 may utilize the stored indication that the first cell and the second cell being able to provide multicast service to the UE 414 when the UE 414 is in the inactive state. The UE 414 may prioritize selection of the cells indicated in the cell list 424 for reselection. In the illustrated example, the UE 414 may prioritize selecting the first cell and the second cell over other cells based on the cell list 424.

The UE 414 may determine which cells are available for selection during the cell reselection procedure 428. When the UE 414 is located in the area located within the first cell area 404, the second cell area 406, and the third cell area 408 in the illustrated example, the UE 414 may determine that the first cell, the second cell, and the third cell are available. The UE 414 may further determine signal quality of the available cells in some embodiments. Since the UE 414 is performing reselection from the first cell (possibly based on the signal quality of the first cell being below a threshold quality), the UE 414 may determine not to select the first cell. The UE 414 may still have the opportunity to select the second cell or the third cell. Since the second cell is indicated within the cell list 424, the UE 414 may determine to prioritize the second cell over the third cell in the illustrated embodiment. Based on the prioritization, the UE 414 may select the second cell to camp on as a result of the cell reselection procedure 428.

The second network element 418 (which corresponds to the second cell) may transmit a broadcast message 430. The broadcast message 430 may include an indication of an inactive multicast configuration to be utilized for processing multicast transmissions transmitted by the second network element 418. Based on the UE 414 selecting to camp on the second cell, the UE 414 may receive and process the broadcast message 430. Based on the broadcast message 430, the UE 414 may be configured with the inactive multicast configuration to process multicast transmissions transmitted by the second network element 418.

The second network element 418 may transmit multicast data 432. The multicast data 432 may correspond to an MBS session #X. The UE 414 may receive the multicast data 432 while the UE 414 is in the inactive state. Further, the UE 414 may utilize the inactive multicast configuration from the broadcast message 430 to process the multicast data 432. Accordingly, the UE 414 may receive and process multicast data while in the inactive state, which was not available by legacy approaches.

While the signaling chart 412 illustrates example signals that may be exchanged by UEs and network elements, it should be understood that additional signals may be included or some of the signals may be omitted in some embodiments. For example, the signals may be part of a larger procedure that includes additional signals.

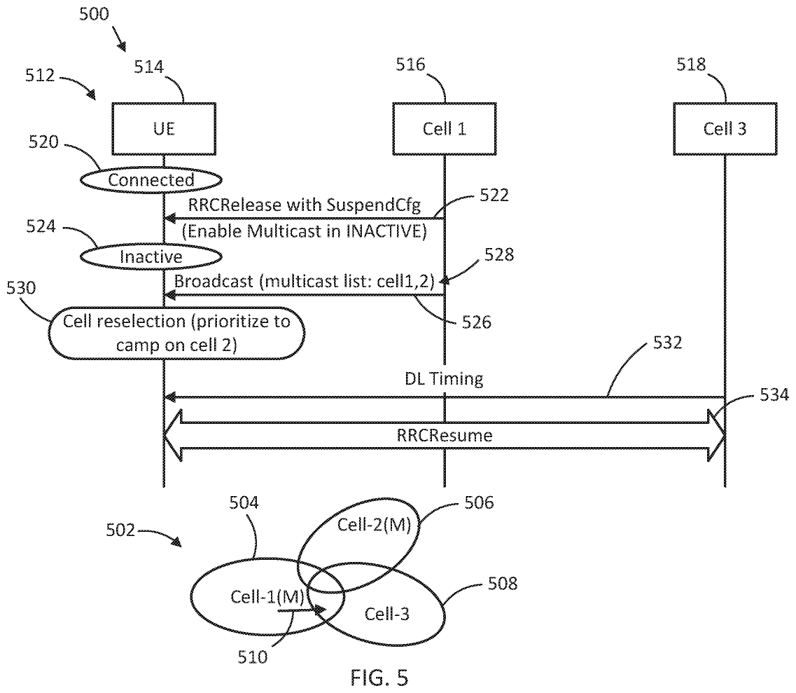

FIG. 5 illustrates an example cell selection arrangement 500 with a single cell list in accordance with some embodiments. In particular, the cell selection arrangement 500 illustrates an example of option 1 where the network may provide a list of cells to indicates cells that support inactive multicast service. In other embodiments, the list of cells may be replaced by a list of frequencies, where the list of frequencies may replace the list of cells in the operation throughout this description.

The cell selection arrangement 500 illustrates an example positional arrangement 502 and an example signaling chart 512 for cell selection with a single cell list. The positional arrangement 502 in the illustrated embodiment indicates a first cell area 504, a second cell area 506, and a third cell area 508. The first cell area 504 indicates an arca that can be serviced by a first cell, the second cell area 506 indicates an area that can be serviced by a second cell, and the third cell area 508 indicates an area that can be service by a third cell.

The positional arrangement 502 further illustrates an arrow 510 that indicates movement of a UE in the area. As can be seen by the arrow 510, the UE starts within the first cell area 504. The UE moves from the first cell area 504 to an area within the first cell area 504 and the third cell area 508 as indicated by the arrow 510. As can be seen by the arrow 510, the UE does not move into the second cell area 506. Based on the movement of the UE indicated by the arrow 510, the UE may determine that a reselection is to be performed from being serviced by the first cell to being serviced by another cell based on the movement toward the edge of the first cell area 504.

The signaling chart 512 may include a UE 514, a first network element 516 corresponding to a first cell, and a second network element 518 corresponding to a third cell. The UE 514 may correspond to the UE illustrated by the arrow 510 in the positional arrangement 502. The first cell of the first network element 516 may correspond to the first cell area 504, where the first cell provides service to the first cell area 504. The third cell of the second network element 518 may correspond to the third cell area 508, where the third cell provides service to the third cell area 508. The UE 514 may include one or more of the features of the UE 1400 (FIG. 14). The first network element 516 and the second network element 518 may each include one or more of the features of the gNB 1500 (FIG. 15).

At the initiation of the signaling chart 512, the UE 514 may be in a connected state, as indicated by connected 520. In particular, the UE 514 may be connected to the first network element 516 based on the UE 514 being located within the first cell area 504 at the initiation of the signaling chart 512.

The first network element 516 may transmit an RRC release with suspend configuration message 522 to the UE 514 to cause the UE 514 to transition to an inactive state. The first network element 516 may transmit the RRC release with suspend configuration message 522 based on the UE 514 moving toward an edge of the first cell arca 504 in some embodiments. In some embodiments, the first network element 516 may transmit the RRC release with suspend configuration message 522 based on conditions for transitioning the UE 514 to the inactive state being met, such as there being a lack of transmissions to be transmitted between the UE 514 and the first network element 516.

The RRC release with suspend configuration message 522 may include an indication to enable multicast reception in an inactive state. In particular, the indication to enable multicast reception may indicate to the UE 514 that multicast reception is to be enabled for the UE 514 when the UE 514 is in the inactive state.

The UE 514 may receive the RRC release with suspend configuration message 522 and identify the RRC release with suspend configuration message 522. The UE 514 may further identify the indication that multicast reception is to be enabled for the UE 514 when the UE 514 is in the inactive state. In some embodiments, the UE 514 may be configured with a configuration for processing multicast transmissions when in the inactive state. The configuration may have been previously received by the UE 514.

The UE 514 may determine that the UE 514 is to transition to the inactive state based on the RRC release with suspend configuration message 522. The UE 514 may transition to the inactive state, as indicated by inactive 524.

The first network element 516 may transmit a broadcast message 526. The first network element 516 may broadcast the broadcast message 526. The broadcast message 526 may include a cell list 528 that indicates one or more cells. The cell list 528 may indicate one or more cells that can provide multicast service to the UE 514 while the UE 514 is in an inactive state. In the illustrated example, the cell list 528 indicates that the first cell and the second cell can provide multicast service to the UE 514 while the UE 514 is in the inactive state.

The UE 514 may receive the broadcast message 526 and identify the broadcast message 526. The UE 514 may further identify the cell list 528 of the broadcast message 526. The UE 514 may determine which cells and/or network elements can provide multicast service to the UE 514 while the UE 514 is in the inactive state. In the illustrated example, the UE 514 may determine that the first cell (which is serviced by the first network element 516) and the second cell can provide multicast service to the UE 514 when the UE 514 is in the inactive state based on the cell list 528. The UE 514 may store the indication of the first cell and the second cell as being able to provide multicast service to the UE 514 when the UE 514 is in the inactive state to be utilized for selecting a cell on which to camp in subsequent cell reselections.

The UE 514 may perform a cell reselection procedure 530 while in the inactive state. The UE 514 may perform the cell reselection procedure 530 based on a condition for cell reselection being met, such as a quality of service provided by a current cell and/or signal strength of signals provided by the current cell falling below a threshold level. In the illustrated example, the UE 514 may perform the cell reselection procedure 530 when the UE 514 is located in the area located within the first cell area 504 and the third cell arca 508.

The UE 514 may utilize the information from the cell list 528 to select a cell on which to camp. For example, the UE 514 may utilize the stored indication that the first cell and the second cell being able to provide multicast service to the UE 514 when the UE 514 is in the inactive state. The UE 514 may prioritize selection of the cells indicated in the cell list 528 for reselection. In the illustrated example, the UE 514 may prioritize selecting the first cell and the second cell over other cells based on the cell list 528.

The UE 514 may determine which cells are available for selection during the cell reselection procedure 530. When the UE 514 is located in the area located within the first cell area 504 and the third cell area 508 in the illustrated example, the UE 514 may determine that the first cell and the third cell are available. The UE 514 may further determine signal quality of the available cells in some embodiments. Since the UE 514 is performing reselection from the first cell (possibly based on the signal quality of the first cell being below a threshold quality), the UE 514 may determine not to select the first cell. The UE 514 may still have the opportunity to select the third cell. Since the first cell and the second cell have been eliminated for selection of service, the UE 514 may determine to select the third cell (corresponding to the second network element 518) for camping since the third cell has been determined to be the only cell available for camping. Since the third cell was not included in the cell list 528 that indicates cells that are available to provide multicast service while the UE 514 is in the inactive state, the UE 514 may determine that the third cell is unable to provide multicast service while the UE 514 is in the inactive state. Accordingly, the UE 514 may determine that the UE 514 has to establish a connection with the second network element 518 corresponding to the third cell to receive multicast data.

The second network element 518 (which corresponds to the third cell) may transmit a downlink (DL) timing message 532. The DL timing message 532 may indicate a DL timing for the second network element 518. The UE 514 may identify the DL timing message 532 received from the second network element 518. The UE 514 may determine the DL timing for the second network element 518, where the UE 514 may utilize the DL timing to communicate with the second network element 518.

The UE 514 may perform an RRC resume procedure 534 to establish a connection with the second network element 518. For example, the UE 514 and the second network element 518 may exchange transmissions during the RRC resume procedure 534 to establish an RRC connection between the UE 514 and the second network element 518. The UE 514 may then utilize the RRC connection to receive multicast data.

While the signaling chart 512 illustrates example signals that may be exchanged by UEs and network elements, it should be understood that additional signals may be included or some of the signals may be omitted in some embodiments. For example, the signals may be part of a larger procedure that includes additional signals.

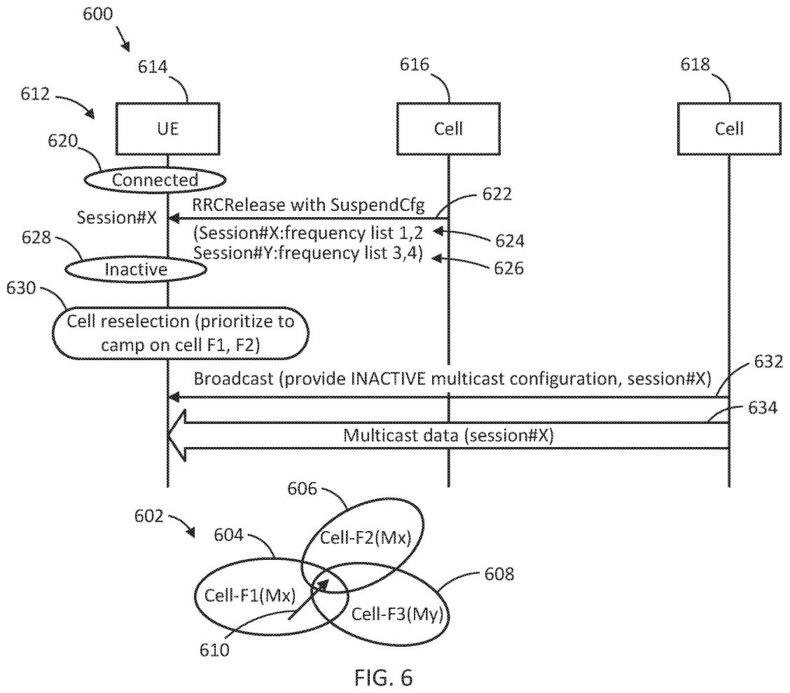

Example 2: the frequency list per MBS session. NW provides the frequency list per MBS session. For example, the NW may provide one or more frequency lists, where each of the frequency lists has a corresponding MBS session for which the frequencies in the frequency list can provide multicast service while a UE is in an inactive state. FIG. 6 illustrates an example cell selection arrangement 600 with frequency lists in accordance with some embodiments. In particular, the cell selection arrangement 600 illustrates an example of option 2 where the network may provide lists of frequencies per multicast MBS session to indicates frequencies that support inactive multicast service for the different multicast MBS sessions. In other embodiments, the lists of frequencies per multicast MBS session may be replaced by lists of cells per multicast MBS session, where the lists of cells may replace the list of frequencies in the operation throughout this description.

The cell selection arrangement 600 illustrates an example positional arrangement 602 and an example signaling chart 612 for cell selection with frequency lists. The positional arrangement 602 in the illustrated embodiment indicates a first cell area 604, a second cell area 606, and a third cell area 608. The first cell area 604 indicates an area that can be serviced by a first cell, the second cell area 606 indicates an area that can be serviced by a second cell, and the third cell area 608 indicates an area that can be service by a third cell. The first cell corresponding to the first cell area 604 may serve a first frequency, the second cell corresponding to the second cell arca 606 may serve a second frequency, and the third cell corresponding to the third cell area 608 may serve a third frequency in the illustrated example.

The positional arrangement 602 further illustrates an arrow 610 that indicates movement of a UE in the area. As can be seen by the arrow 610, the UE starts within the first cell area 604. The UE moves from the first cell area 604 to an area within the first cell area 604, the second cell area 606, and the third cell area 608 as indicated by the arrow 610. Based on the movement of the UE indicated by the arrow 610, the UE may determine that a reselection is to be performed from being serviced by the first cell to being serviced by another cell based on the movement toward the edge of the first cell area 604.

The signaling chart 612 may include a UE 614, a first network element 616 corresponding to a first cell, and a second network element 618 corresponding to a second cell. The UE 614 may correspond to the UE illustrated by the arrow 610 in the positional arrangement 602. The first cell of the first network element 616 may correspond to the first cell area 604, where the first cell provides service to the first cell area 604. The second cell of the second network element 618 may correspond to the second cell area 606, where the second cell provides service to the second cell area 606. The UE 614 may include one or more of the features of the UE 1400 (FIG. 14). The first network element 616 and the second network element 618 may each include one or more of the features of the gNB 1500 (FIG. 15).

At the initiation of the signaling chart 612, the UE 614 may be in a connected state, as indicated by connected 620. In particular, the UE 614 may be connected to the first network element 616 based on the UE 614 being located within the first cell area 604 at the initiation of the signaling chart 612.

The first network element 616 may transmit an RRC release with suspend configuration message 622 to the UE 614 to cause the UE 614 to transition to an inactive state. The first network element 616 may transmit the RRC release with suspend configuration message 622 based on the UE 614 moving toward an edge of the first cell area 604 in some embodiments. In some embodiments, the first network element 616 may transmit the RRC release with suspend configuration message 622 based on conditions for transitioning the UE 614 to the inactive state being met, such as there being a lack of transmissions to be transmitted between the UE 614 and the first network element 616.

The RRC release with suspend configuration message 622 may include a first frequency list 624 corresponding to a multicast MBS session #X and a second frequency list 626 corresponding to a multicast MBS session #Y. The first frequency list 624 may indicate one or more frequencies that can provide multicast service for the multicast MBS session #X when the UE 614 is in the inactive state. The second frequency list 626 may indicate one or more frequencies that can provide multicast service for the multicast MBS session #Y when the UE 614 is in the inactive state. In the illustrated example, the first frequency list 624 indicates that a first frequency and a second frequency can provide multicast service to the UE 614 for multicast MBS session #X while the UE 614 is in the inactive state. Further in the illustrated example, the second frequency list 626 indicates that a third frequency and a fourth frequency can provide multicast service to the UE 614 for multicast MBS session #Y while the UE 614 is in the inactive state.

The UE 614 may receive the RRC release with suspend configuration message 622 and identify the RRC release with suspend configuration message 622. The UE 614 may further identify the first frequency list 624 and the second frequency list 626 of the RRC release with suspend configuration message 622. The UE 614 may determine which frequencies and/or network elements can provide multicast service to the UE 614 for each multicast MBS session while the UE 614 is in the inactive state. In the illustrated example, the UE 614 may determine that the first frequency (which is supported by the first network clement 616) and the second frequency (which is supported by the second network element 618) can provide multicast service to the UE 614 for the multicast MBS session #X when the UE 614 is in the inactive state based on the first frequency list 624. Further, the UE 614 may determine that the third frequency and the fourth frequency can provide multicast service to the UE 614 for the multicast MBS session #Y when the UE 614 is in the inactive state based on the second frequency list 626. The UE 614 may store the indication of the frequencies for each multicast MBS session able to provide multicast service to the UE 614 when the UE 614 in in the inactive state. In some embodiments, the UE 614 may store an indication of the frequencies for a multicast MBS session of which the UE 614 is configured. In the illustrated embodiment, the UE 614 may be configured for multicast MBS session #X and may store the indication of the frequencies for the multicast MBS session #X.

The UE 614 may determine that the UE 614 is to transition to the inactive state based on the RRC release with suspend configuration message 622. The UE 614 may transition to the inactive state, as indicated by inactive 628.

The UE 614 may perform a cell reselection procedure 630 while in the inactive state. The UE 614 may perform the cell reselection procedure 630 based on a condition for cell reselection being met, such as a quality of service provided by a current cell and/or signal strength of signals provided by the current cell falling below a threshold level. In the illustrated example, the UE 614 may perform the cell reselection procedure 630 when the UE 614 is located in the area located within the first cell area 604, the second cell arca 606, and the third cell arca 608.

The UE 614 may utilize the information from the first frequency list 624 and/or the second frequency list 626 to select a cell on which to camp. For example, the UE 614 may determine that the UE 614 is configured for session #X. The UE 614 may determine to utilize the stored indication that the first frequency and the second frequency being able to provide multicast service to the UE 614 for the session #X when the UE 614 is in the inactive state. The UE 614 may prioritize selection of network elements providing the frequencies indicated in the first frequency list 624 for reselection. In the illustrated example, the UE 614 may prioritize selecting network elements that provide the first frequency and the second frequency over network elements that provide other frequencies based on the first frequency list 624.

The UE 614 may determine which frequencies are available for selection during the cell reselection procedure 630. When the UE 614 is located in the area located within the first cell area 604, the second cell area 606, and the third cell area 608 in the illustrated example, the UE 614 may determine that the first frequency, the second frequency, and the third frequency are available. The UE 614 may further determine signal quality corresponding to the available frequencies in some embodiments. Since the UE 614 is performing reselection from the first cell that provides the first frequency (possibly based on the signal quality of the first cell being below a threshold quality), the UE 614 may determine not to select the first cell. The UE 614 may still have the opportunity to select the second cell that provides the second frequency or the third cell that provides the third frequency. Since the second frequency is indicated within the first frequency list 624 corresponding to the multicast MBS session #X, the UE 614 may determine to prioritize the second cell that provides the second frequency over the third cell that provides the third frequency in the illustrated embodiment. Based on the prioritization, the UE 614 may select the second cell to camp on as a result of the cell reselection procedure 630.

The second network element 618 (which corresponds to the second cell) may transmit a broadcast message 632. The broadcast message 632 may include an indication of an inactive multicast configuration to be utilized for processing multicast transmissions of the multicast MBS session #X transmitted by the second network element 618. Based on the UE 614 selecting to camp on the second cell, the UE 614 may receive and process the broadcast message 632. Based on the broadcast message 632, the UE 614 may be configured with the inactive multicast configuration to process multicast transmissions of the multicast MBS session #X transmitted by the second network element 618.

The second network element 618 may transmit multicast data 634. The multicast data 634 may correspond to an MBS session #X. The UE 614 may receive the multicast data 634 while the UE 614 is in the inactive state. Further, the UE 614 may utilize the inactive multicast configuration from the broadcast message 632 to process the multicast data 634. Accordingly, the UE 614 may receive and process multicast data while in the inactive state, which was not available by legacy approaches.

While the signaling chart 612 illustrates example signals that may be exchanged by UEs and network elements, it should be understood that additional signals may be included or some of the signals may be omitted in some embodiments. For example, the signals may be part of a larger procedure that includes additional signals.

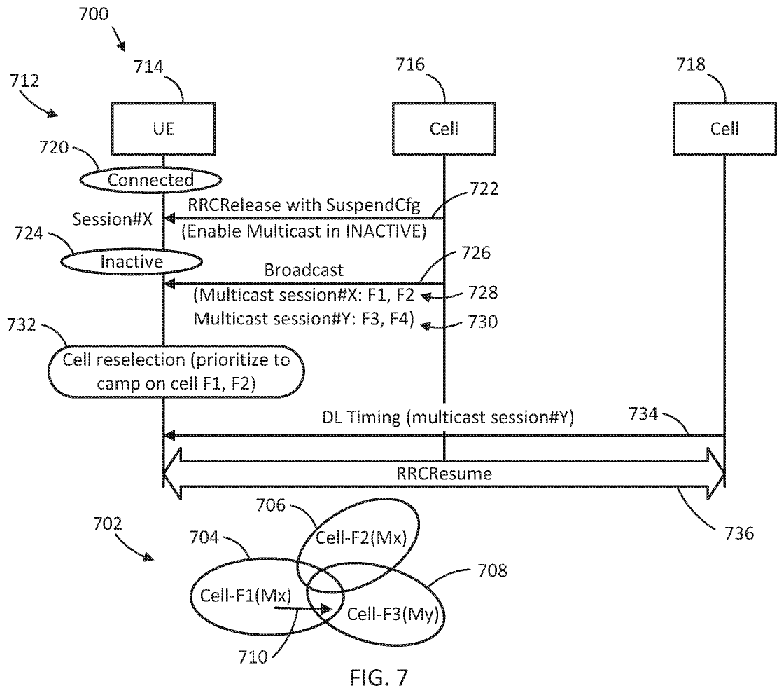

FIG. 7 illustrates an example cell selection arrangement 700 with frequency lists in accordance with some embodiments. In particular, the cell selection arrangement 700 illustrates an example of option 2 where the network may provide lists of frequencies per multicast MBS session to indicates frequencies that support inactive multicast service for the different multicast MBS sessions. In other embodiments, the lists of frequencies per multicast MBS session may be replaced by lists of cells per multicast MBS session, where the lists of cells may replace the list of frequencies in the operation throughout this description.

The cell selection arrangement 700 illustrates an example positional arrangement 702 and an example signaling chart 712 for cell selection with frequency lists. The positional arrangement 702 in the illustrated embodiment indicates a first cell arca 704, a second cell area 706, and a third cell area 708. The first cell arca 704 indicates an arca that can be serviced by a first cell, the second cell area 706 indicates an area that can be serviced by a second cell, and the third cell area 708 indicates an area that can be service by a third cell. The first cell corresponding to the first cell area 704 may serve a first frequency, the second cell corresponding to the second cell area 706 may serve a second frequency, and the third cell corresponding to the third cell area 708 may serve a third frequency in the illustrated example. Further, the first cell corresponding to the first cell arca 704 and the second cell corresponding to the second cell area 706 may correspond to a multicast MBS session #X. The third cell corresponding to the third cell area 708 may correspond to a multicast MBS session #Y.

The positional arrangement 702 further illustrates an arrow 710 that indicates movement of a UE in the area. As can be seen by the arrow 710, the UE starts within the first cell arca 704. The UE moves from the first cell area 704 to an area within the first cell arca 704 and the third cell area 708 as indicated by the arrow 710. As can be seen by the arrow 710, the UE does not move into the second cell area 706. Based on the movement of the UE indicated by the arrow 710, the UE may determine that a reselection is to be performed from being serviced by the first cell to being serviced by another cell based on the movement toward the edge of the first cell arca 704.

The signaling chart 712 may include a UE 714, a first network element 716 corresponding to a first cell, and a second network element 718 corresponding to a third cell. The UE 714 may correspond to the UE illustrated by the arrow 710 in the positional arrangement 702. The first cell of the first network element 716 may correspond to the first cell area 704, where the first cell provides service to the first cell area 704. The third cell of the second network element 718 may correspond to the third cell area 708, where the third cell provides service to the third cell area 708. The UE 714 may include one or more of the features of the UE 1400 (FIG. 14). The first network element 716 and the second network clement 718 may each include one or more of the features of the gNB 1500 (FIG. 15).

At the initiation of the signaling chart 712, the UE 714 may be in a connected state, as indicated by connected 720. In particular, the UE 714 may be connected to the first network element 716 based on the UE 714 being located within the first cell area 704 at the initiation of the signaling chart 712.

The first network element 716 may transmit an RRC release with suspend configuration message 722 to the UE 714 to cause the UE 714 to transition to an inactive state. The first network element 716 may transmit the RRC release with suspend configuration message 722 based on the UE 714 moving toward an edge of the first cell arca 704 in some embodiments. In some embodiments, the first network element 716 may transmit the RRC release with suspend configuration message 722 based on conditions for transitioning the UE 714 to the inactive state being met, such as there being a lack of transmissions to be transmitted between the UE 714 and the first network element 716.

The RRC release with suspend configuration message 722 may include an indication to enable multicast reception in an inactive state. In particular, the indication to enable multicast reception may indicate to the UE 714 that multicast reception is to be enabled for the UE 714 when the UE 714 is in the inactive state.

The UE 714 may receive the RRC release with suspend configuration message 722 and identify the RRC release with suspend configuration message 722. The UE 714 may further identify the indication that multicast reception is to be enabled for the UE 714 when the UE 714 is in the inactive state. In some embodiments, the UE 714 may be configured with a configuration for processing multicast transmissions when in the inactive state. The configuration may have been previously received by the UE 714.

The UE 714 may determine that the UE 714 is to transition to the inactive state based on the RRC release with suspend configuration message 722. The UE 714 may transition to the inactive state, as indicated by inactive 724.

The first network element 716 may transmit a broadcast message 726. The first network element 716 may broadcast the broadcast message 726. The broadcast message 726 may include a first frequency list 728 corresponding to a multicast MBS session #X and a second frequency list 730 corresponding to a multicast MBS session #Y. The first frequency list 728 may indicate one or more frequencies that can provide multicast service for the multicast MBS session #X when the UE 714 is in the inactive state. The second frequency list 730 may indicate one or more frequencies that can provide multicast service for the multicast MBS session #Y when the UE 714 is in the inactive state. In the illustrated example, the first frequency list 728 indicates that a first frequency and a second frequency can provide multicast service to the UE 714 for multicast MBS session #X while the UE 714 is in the inactive state. Further in the illustrated example, the second frequency list 730 indicates that a third frequency and a fourth frequency can provide multicast service to the UE 714 for multicast MBS session #Y while the UE 714 is in the inactive state.

The UE 714 may receive the broadcast message 726 and identify the broadcast message 726. The UE 714 may further identify the first frequency list 728 and the second frequency list 730 of the broadcast message 726. The UE 714 may determine which frequencies and/or network elements can provide multicast service to the UE 714 for each multicast MBS session while the UE 714 is in the inactive state. In the illustrated example, the UE 714 may determine that the first frequency (which is supported by the first network element 716) and the second frequency (which is supported by the second network element 718) can provide multicast service to the UE 714 for the multicast MBS session #X when the UE 714 is in the inactive state based on the first frequency list 728. Further, the UE 714 may determine that the third frequency and the fourth frequency can provide multicast service to the UE 714 for the multicast MBS session #Y when the UE 714 is in the inactive state based on the second frequency list 730. The UE 714 may store the indication of the frequencies for each multicast MBS session able to provide multicast service to the UE 714 when the UE 714 in in the inactive state. In some embodiments, the UE 714 may store an indication of the frequencies for a multicast MBS session of which the UE 714 is configured. In the illustrated embodiment, the UE 714 may be configured for multicast MBS session #X and may store the indication of the frequencies for the multicast MBS session #X.

The UE 714 may perform a cell reselection procedure 732 while in the inactive state. The UE 714 may perform the cell reselection procedure 732 based on a condition for cell reselection being met, such as a quality of service provided by a current cell and/or signal strength of signals provided by the current cell falling below a threshold level. In the illustrated example, the UE 714 may perform the cell reselection procedure 732 when the UE 714 is located in the area located within the first cell area 704 and the third cell arca 708.

The UE 714 may utilize the information from the first frequency list 728 and/or the second frequency list 730 to select a cell on which to camp. For example, the UE 714 may determine that the UE 714 is configured for session #X. The UE 714 determine to utilize the stored indication that the first frequency and the second frequency being able to provide multicast service to the UE 714 for the session #X when the UE 714 is in the inactive state. The UE 714 may prioritize selection of network elements providing the frequencies indicated in the first frequency list 728 for reselection. In the illustrated example, the UE 714 may prioritize selecting network elements that provide the first frequency and the second frequency over network elements that provide other frequencies based on the first frequency list 728.

The UE 714 may determine which frequencies are available for selection during the cell reselection procedure 732. When the UE 714 is located in the area located within the first cell area 704 and the third cell area 708 in the illustrated example, the UE 714 may determine that the first frequency and the third frequency are available. The UE 714 may further determine signal quality corresponding to the available frequencies in some embodiments. Since the UE 714 is performing reselection from the first cell that provides the first frequency (possibly based on the signal quality of the first cell being below a threshold quality), the UE 714 may determine not to select the first cell. The UE 614 may still have the opportunity to select the third cell that provides the third frequency. Since the third cell was not included in the first frequency list 728 that indicates cells that are available to provide multicast service for multicast MBS session #X while the UE 714 is in the inactive state, the UE 714 may determine that the third cell is unable to provide multicast service while the UE 714 is in the inactive state. Accordingly, the UE 714 may determine that the UE 714 has to establish a connection with the second network element 718 corresponding to the third cell to receive multicast data for multicast MBS session #X.

The second network element 718 (which corresponds to the third cell) may transmit a DL timing message 734. The DL timing message 734 may indicate a DL timing for the second network element 718. The UE 714 may identify the DL timing message 734 received from the second network element 718. The UE 714 may determine the DL timing for the second network element 718, where the UE 714 may utilize the DL timing to communicate with the second network element 718.

The UE 714 may perform an RRC resume procedure 736 to establish a connection with the second network element 718. For example, the UE 714 and the second network element 718 may exchange transmissions during the RRC resume procedure 736 to establish an RRC connection between the UE 714 and the second network element 718. The UE 714 may then utilize the RRC connection to receive multicast data.

While the signaling chart 712 illustrates example signals that may be exchanged by UEs and network elements, it should be understood that additional signals may be included or some of the signals may be omitted in some embodiments. For example, the signals may be part of a larger procedure that includes additional signals.

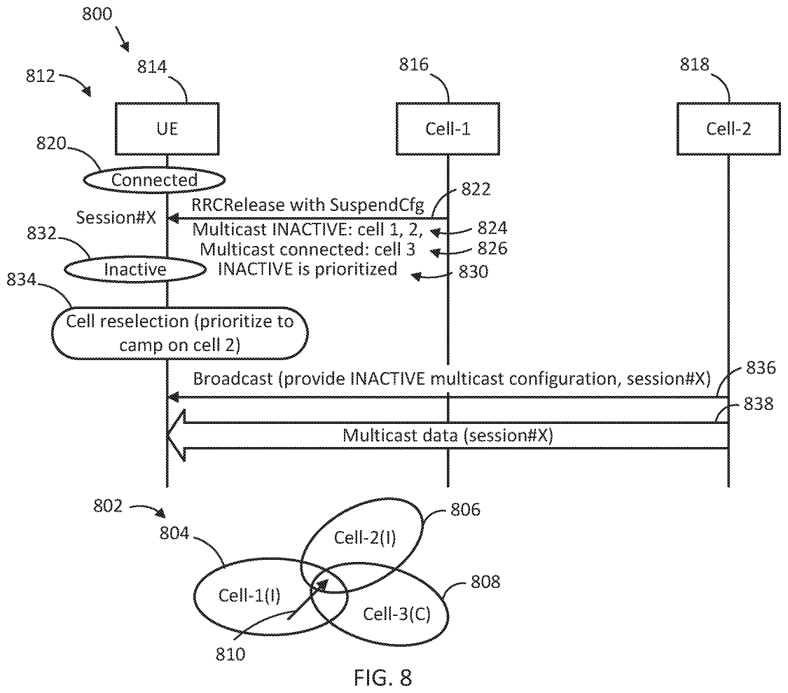

Example 3: the cell list per RRC state. NW provides the cell list per RRC state. For example, the NW may provide one or more cell lists, where each of the cell lists has a corresponding state of a UE in which the cells within the cell list can provide multicast service. FIG. 8 illustrates an example cell selection arrangement 800 with cell lists in accordance with some embodiments. In particular, the cell selection arrangement 800 illustrates an example of option 3 where the network may provide two lists of cells, one list corresponding to an inactive state and one list corresponding to a connected state. In other embodiments, the lists of cells for each of the states may be replaced by lists of frequencies for each of the states, where the lists of frequencies may replace the list of cells in the operation throughout this description.

The cell selection arrangement 800 illustrates an example positional arrangement 802 and an example signaling chart 812 for cell selection with cell lists. The positional arrangement 802 in the illustrated embodiment indicates a first cell arca 804, a second cell area 806, and a third cell area 608. The first cell arca 804 indicates an arca that can be serviced by a first cell, the second cell area 806 indicates an area that can be serviced by a second cell, and the third cell area 808 indicates an area that can be service by a third cell. The first cell corresponding to the first cell area 804 and the second cell corresponding to the second cell area 806 may provide multicast service when a UE is in an inactive state. The third cell corresponding to the third cell area 808 may serve a provide multicast service when a UE is in a connected state.

The positional arrangement 802 further illustrates an arrow 810 that indicates movement of a UE in the area. As can be seen by the arrow 810, the UE starts within the first cell area 804. The UE moves from the first cell area 804 to an area within the first cell arca 804, the second cell area 806, and the third cell arca 808 as indicated by the arrow 810. Based on the movement of the UE indicated by the arrow 810, the UE may determine that a reselection is to be performed from being serviced by the first cell to being serviced by another cell based on the movement toward the edge of the first cell arca 804.

The signaling chart 812 may include a UE 814, a first network element 816 corresponding to a first cell, and a second network element 818 corresponding to a second cell. The UE 814 may correspond to the UE illustrated by the arrow 810 in the positional arrangement 802. The first cell of the first network element 816 may correspond to the first cell area 804, where the first cell provides service to the first cell area 804. The second cell of the second network element 818 may correspond to the second cell area 806, where the second cell provides service to the second cell area 806. The UE 814 may include one or more of the features of the UE 1400 (FIG. 14). The first network element 816 and the second network element 818 may each include one or more of the features of the gNB 1500 (FIG. 15).

At the initiation of the signaling chart 812, the UE 814 may be in a connected state, as indicated by connected 820. In particular, the UE 814 may be connected to the first network element 816 based on the UE 814 being located within the first cell area 804 at the initiation of the signaling chart 812.

The first network element 816 may transmit an RRC release with suspend configuration message 822 to the UE 814 to cause the UE 814 to transition to an inactive state. The first network element 816 may transmit the RRC release with suspend configuration message 822 based on the UE 814 moving toward an edge of the first cell area 804 in some embodiments. In some embodiments, the first network element 816 may transmit the RRC release with suspend configuration message 822 based on conditions for transitioning the UE 814 to the inactive state being met, such as there being a lack of transmissions to be transmitted between the UE 814 and the first network element 816.

The RRC release with suspend configuration message 822 may include a first cell list 824 corresponding to the inactive state and a second cell list 826 corresponding to the connected state. The first cell list 824 may indicate one or more cells that can provide multicast service when the UE 814 is in the inactive state. The second cell list 826 may indicate one or more cells that can provide multicast service to UE 814 is in the connected state. In the illustrated example, the first cell list 824 indicates that a first cell and a second cell can provide multicast service to the UE 814 while the UE 814 is in the inactive state. Further in the illustrated example, the second cell list 826 indicates that a third cell can provide multicast service to the UE 814 while the UE 814 is in the connected state. The RRC release with suspend configuration message 822 may further indicate a prioritized state 830 of the UE 814 for receipt of multicast data. In the illustrated example, the prioritized state 830 may indicate that the inactive state of the UE 814 is prioritized over other states, including the connected state.

The UE 814 may receive the RRC release with suspend configuration message 822 and identify the RRC release with suspend configuration message 822. The UE 814 may further identify the first cell list 824, the second cell list 826, and the prioritized state 830 of the RRC release with suspend configuration message 822. The UE 814 may store the indication of the cells that can provide multicast service in the inactive state, the indication of the cells that can provide multicast service in the connected state, and/or the indication of the prioritized state 830.

The UE 814 may determine that the UE 814 is to transition to the inactive state based on the RRC release with suspend configuration message 822. The UE 814 may transition to the inactive state, as indicated by inactive 832.

The UE 814 may perform a cell reselection procedure 834 while in the inactive state. The UE 814 may perform the cell reselection procedure 834 based on a condition for cell reselection being met, such as a quality of service provided by a current cell and/or signal strength of signals provided by the current cell falling below a threshold level. In the illustrated example, the UE 814 may perform the cell reselection procedure 834 when the UE 814 is located in the area located within the first cell area 804, the second cell area 806, and the third cell arca 808.

The UE 814 may utilize the information from the first cell list 824, the second cell list 826, and/or the prioritized state 830 to select a cell on which to camp. For example the UE 814 may determine that receiving the multicast data while the UE 814 is in the inactive state is to be prioritized based on the prioritized state 830. Further, the UE 814 may determine that the first cell and the second cell are to be prioritized based on the first cell and the second cell being included the first cell list 824 since the first cell list 824 corresponds to the inactive state.

The UE 814 may determine which cells are available for selection during the cell reselection procedure 834. When the UE 814 is located in the area located within the first cell area 804, the second cell area 806, and the third cell area 808 in the illustrated example, the UE 814 may determine that the first cell, the second cell, and the third cell are available. The UE 814 may further determine signal quality corresponding to the available cells in some embodiments. Since the UE 814 is performing reselection from the first cell (possibly based on the signal quality of the first cell being below a threshold quality), the UE 814 may determine not to select the first cell. The UE 814 may still have the opportunity to select the second cell or the third cell. Since the inactive state is indicated as being prioritized by the prioritized state 830 and the second cell is indicated within the first cell list 824 corresponding to the inactive state, the UE 814 may determine to prioritize the second cell that provides multicast service when in the UE 814 is in the inactive state over the third cell that provides multicast service when the UE 814 is in the connected state in the illustrated example. Based on the prioritization, the UE 814 may select the second cell to camp on as a result of the cell reselection procedure 834.

The second network element 818 (which corresponds to the second cell) may transmit a broadcast message 836. The broadcast message 836 may include an indication of an inactive multicast configuration to be utilized for processing multicast transmissions of the multicast MBS session #X transmitted by the second network element 818. Based on the UE 814 selecting to camp on the second cell, the UE 814 may receive and process the broadcast message 836. Based on the broadcast message 836, the UE 814 may be configured with the inactive multicast configuration to process multicast transmissions of the multicast MBS session #X transmitted by the second network element 818.

The second network element 818 may transmit multicast data 838. The multicast data 838 may correspond to an MBS session #X. The UE 814 may receive the multicast data 838 while the UE 814 is in the inactive state. Further, the UE 814 may utilize the inactive multicast configuration from the broadcast message 836 to process the multicast data 838. Accordingly, the UE 814 may receive and process multicast data while in the inactive state, which was not available by legacy approaches.

While the signaling chart 812 illustrates example signals that may be exchanged by UEs and network elements, it should be understood that additional signals may be included or some of the signals may be omitted in some embodiments. For example, the signals may be part of a larger procedure that includes additional signals.

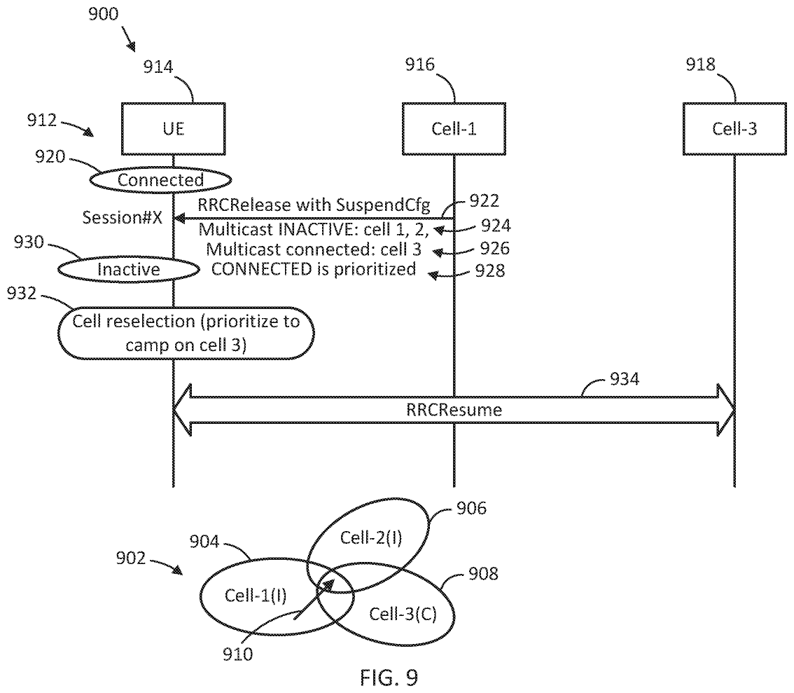

FIG. 9 illustrates an example cell selection arrangement 900 with cell lists in accordance with some embodiments. In particular, the cell selection arrangement 900 illustrates an example of option 3 where the network may provide two lists of cells, one list corresponding to an inactive state and one list corresponding to a connected state. In other embodiments, the lists of cells for each of the states may be replaced by lists of frequencies for each of the states, where the lists of frequencies may replace the list of cells in the operation throughout this description.

The cell selection arrangement 900 illustrates an example positional arrangement 902 and an example signaling chart 912 for cell selection with cell lists. The positional arrangement 902 in the illustrated embodiment indicates a first cell area 904, a second cell area 906, and a third cell area 908. The first cell area 904 indicates an arca that can be serviced by a first cell, the second cell area 906 indicates an area that can be serviced by a second cell, and the third cell area 908 indicates an arca that can be service by a third cell. The first cell corresponding to the first cell area 904 and the second cell corresponding to the second cell area 906 may provide multicast service when a UE is in an inactive state. The third cell corresponding to the third cell area 908 may serve a provide multicast service when a UE is in a connected state.

The positional arrangement 902 further illustrates an arrow 910 that indicates movement of a UE in the area. As can be seen by the arrow 910, the UE starts within the first cell area 904. The UE moves from the first cell area 904 to an area within the first cell arca 904, the second cell area 906, and the third cell area 908 as indicated by the arrow 810. Based on the movement of the UE indicated by the arrow 910, the UE may determine that a reselection is to be performed from being serviced by the first cell to being serviced by another cell based on the movement toward the edge of the first cell area 904.

The signaling chart 912 may include a UE 914, a first network element 916 corresponding to a first cell, and a second network element 918 corresponding to a third cell. The UE 914 may correspond to the UE illustrated by the arrow 910 in the positional arrangement 902. The first cell of the first network element 916 may correspond to the first cell area 904, where the first cell provides service to the first cell area 904. The third cell of the second network element 918 may correspond to the third cell area 908, where the third cell provides service to the third cell area 908. The UE 914 may include one or more of the features of the UE 1400 (FIG. 14). The first network element 916 and the second network clement 918 may each include one or more of the features of the gNB 1500 (FIG. 15).

At the initiation of the signaling chart 912, the UE 914 may be in a connected state, as indicated by connected 920. In particular, the UE 914 may be connected to the first network element 916 based on the UE 914 being located within the first cell area 904 at the initiation of the signaling chart 912.

The first network element 916 may transmit an RRC release with suspend configuration message 922 to the UE 914 to cause the UE 914 to transition to an inactive state. The first network clement 916 may transmit the RRC release with suspend configuration message 922 based on the UE 914 moving toward an edge of the first cell area 904 in some embodiments. In some embodiments, the first network element 916 may transmit the RRC release with suspend configuration message 922 based on conditions for transitioning the UE 914 to the inactive state being met, such as there being a lack of transmissions to be transmitted between the UE 914 and the first network element 916.

The RRC release with suspend configuration message 922 may include a first cell list 924 corresponding to the inactive state and a second cell list 926 corresponding to the connected state. The first cell list 924 may indicate one or more cells that can provide multicast service when the UE 914 is in the inactive state. The second cell list 926 may indicate one or more cells that can provide multicast service to UE 914 is in the connected state. In the illustrated example, the first cell list 924 indicates that a first cell and a second cell can provide multicast service to the UE 914 while the UE 914 is in the inactive state. Further in the illustrated example, the second cell list 926 indicates that a third cell can provide multicast service to the UE 914 while the UE 914 is in the connected state. The RRC release with suspend configuration message 922 may further indicate a prioritized state 928 of the UE 914 for receipt of multicast data. In the illustrated example, the prioritized state 928 may indicate that the connected state of the UE 914 is prioritized over other states, including the inactive state.

The UE 914 may receive the RRC release with suspend configuration message 922 and identify the RRC release with suspend configuration message 922. The UE 914 may further identify the first cell list 924, the second cell list 926, and the prioritized state 928 of the RRC release with suspend configuration message 922. The UE 914 may store the indication of the cells that can provide multicast service in the inactive state, the indication of the cells that can provide multicast service in the connected state, and/or the indication of the prioritized state 928.

The UE 914 may determine that the UE 914 is to transition to the inactive state based on the RRC release with suspend configuration message 922. The UE 914 may transition to the inactive state, as indicated by inactive 930.

The UE 914 may perform a cell reselection procedure 932 while in the inactive state. The UE 914 may perform the cell reselection procedure 932 based on a condition for cell reselection being met, such as a quality of service provided by a current cell and/or signal strength of signals provided by the current cell falling below a threshold level. In the illustrated example, the UE 914 may perform the cell reselection procedure 932 when the UE 914 is located in the area located within the first cell area 904, the second cell area 906, and the third cell arca 908.

The UE 914 may utilize the information from the first cell list 924, the second cell list 926, and/or the prioritized state 928 to select a cell on which to camp. For example the UE 914 may determine that receiving the multicast data while the UE 914 is in the connected state is to be prioritized based on the prioritized state 928. Further, the UE 914 may determine that the third cell is to be prioritized based on the third cell being included in the second cell list 926 since the second cell list 926 corresponds to the connected state.

The UE 914 may determine which cells are available for selection during the cell reselection procedure 932. When the UE 914 is located in the area located within the first cell area 904, the second cell area 906, and the third cell area 908 in the illustrated example, the UE 914 may determine that the first cell, the second cell, and the third cell are available. The UE 914 may further determine signal quality corresponding to the available cells in some embodiments. Since the UE 914 is performing reselection from the first cell (possibly based on the signal quality of the first cell being below a threshold quality), the UE 914 may determine not to select the first cell. The UE 914 may still have the opportunity to select the second cell or the third cell. Since the connected state is indicated as being prioritized by the prioritized state 928 and the third cell is indicated within the second cell list 926 corresponding to the connected state, the UE 914 may determine to prioritize the third cell that provides multicast service when in the UE 914 is in the connected state over the second cell that provides multicast service when the UE 914 is in the inactive state in the illustrated example. Based on the prioritization, the UE 914 may select the third cell to camp on as a result of the cell reselection procedure 932.

The UE 914 may perform an RRC resume procedure 934 to establish a connection with the second network element 918. For example, the UE 914 and the second network element 918 may exchange transmissions during the RRC resume procedure 934 to establish an RRC connection between the UE 914 and the second network element 918. The UE 914 may then utilize the RRC connection to receive multicast data.

While the signaling chart 912 illustrates example signals that may be exchanged by UEs and network elements, it should be understood that additional signals may be included or some of the signals may be omitted in some embodiments. For example, the signals may be part of a larger procedure that includes additional signals.

Example 4: RRC release with redirection to multicast carrier/cell. NW is aware that UE has joint multicast MBS session. When NW release the UE, NW can enable the RRC redirection functionality and redirect the UE to the frequency/cell with the INACTIVE multicast service. For example, the NW may indicate the frequency and/or cell that provides multicast service while the UE is in the inactive state, which may indicate that the UE is to select the indication frequency and/or cell on which to camp. NOTE: Reuse RRCRelease with Redirection mechanism. UE can keep the prioritization configuration for a period (controlled by the redirection timer.)

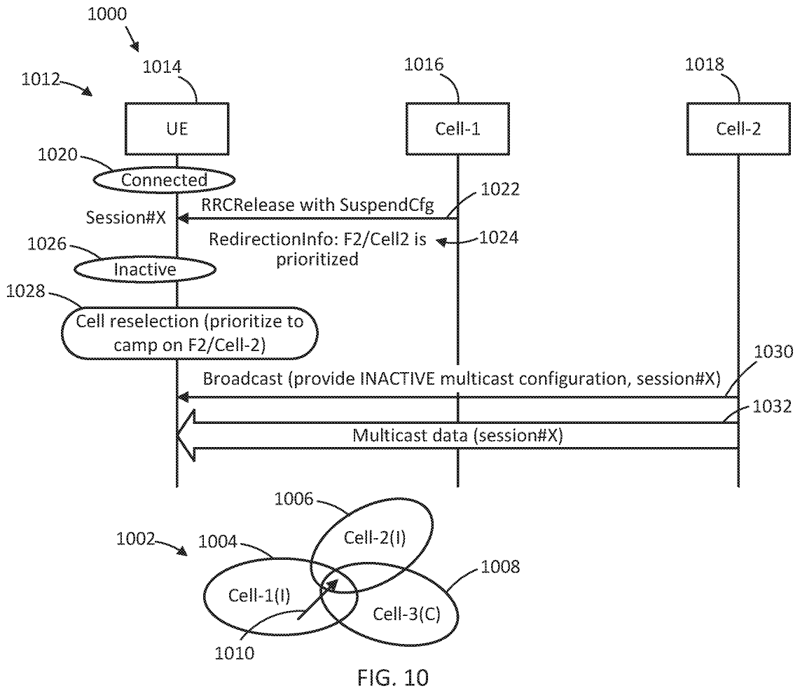

FIG. 10 illustrates an example cell selection arrangement 1000 with a frequency/cell list in accordance with some embodiments. In particular, the cell selection arrangement 1000 illustrates an example where the network may indicate a particular frequency and/or cell that a UE is to select for camping. The particular frequency and/or cell may provide multicast service while the UE is in the inactive state.

The cell selection arrangement 1000 illustrates an example positional arrangement 1002 and an example signaling chart 1012 for cell selection with a frequency/cell list. The positional arrangement 1002 in the illustrated embodiment indicates a first cell area 1004, a second cell area 1006, and a third cell area 1008. The first cell area 1004 indicates an area that can be serviced by a first cell, the second cell area 1006 indicates an area that can be serviced by a second cell, and the third cell area 1008 indicates an arca that can be service by a third cell.

The positional arrangement 1002 further illustrates an arrow 1010 that indicates movement of a UE in the area. As can be seen by the arrow 1010, the UE starts within the first cell area 1004. The UE moves from the first cell area 1004 to an arca within the first cell arca 1004, the second cell area 1006, and the third cell area 1008 as indicated by the arrow 1010. Based on the movement of the UE indicated by the arrow 1010, the UE may determine that a reselection is to be performed from being serviced by the first cell to being serviced by another cell based on the movement toward the edge of the first cell arca 1004.

The signaling chart 1012 may include a UE 1014, a first network element 1016 corresponding to a first cell, and a second network element 1018 corresponding to a second cell. The UE 1014 may correspond to the UE illustrated by the arrow 1010 in the positional arrangement 1002. The first cell of the first network element 1016 may correspond to the first cell area 1004, where the first cell provides service to the first cell area 1004. The second cell of the second network element 1018 may correspond to the second cell area 1006, where the second cell provides service to the second cell area 1006. The UE 1014 may include one or more of the features of the UE 1400 (FIG. 14). The first network element 1016 and the second network element 1018 may each include one or more of the features of the gNB 1500 (FIG. 15).

At the initiation of the signaling chart 1012, the UE 1014 may be in a connected state, as indicated by connected 1020. In particular, the UE 1014 may be connected to the first network element 1016 based on the UE 1014 being located within the first cell area 1004 at the initiation of the signaling chart 1012.

The first network clement 1016 may transmit an RRC release with suspend configuration message 1022 to the UE 1014 to cause the UE 1014 to transition to an inactive state. The first network element 1016 may transmit the RRC release with suspend configuration message 1022 based on the UE 1014 moving toward an edge of the first cell area 1004 in some embodiments. In some embodiments, the first network element 1016 may transmit the RRC release with suspend configuration message 1022 based on conditions for transitioning the UE 1014 to the inactive state being met, such as there being a lack of transmissions to be transmitted between the UE 1014 and the first network element 1016.

The RRC release with suspend configuration message 1022 may include an indication of a resource 1024 to which the UE 1014 is to be redirected in a subsequent cell reselection. The resource 1024 may be a frequency and/or a cell to which the UE 1014 is to select for camping. In the illustrated embodiment, the resource 1024 may indicate that the UE 1014 is to select a second frequency and a second cell to camp, if available.

The UE 1014 may receive the RRC release with suspend configuration message 1022 and identify the RRC release with suspend configuration message 1022. The UE 1014 may further identify the indication of the resource 1024. The UE 1014 may store the indication of the resource 1024. For example, the UE may store the indication of the second frequency and the second cell for cell selection.

The UE 1014 may determine that the UE 1014 is to transition to the inactive state based on the RRC release with suspend configuration message 1022. The UE 1014 may transition to the inactive state, as indicated by inactive 1026.

The UE 1014 may perform a cell reselection procedure 1028 while in the inactive state. The UE 1014 may perform the cell reselection procedure 1028 based on a condition for cell reselection being met, such as a quality of service provided by a current cell and/or signal strength of signals provided by the current cell falling below a threshold level. In the illustrated example, the UE 1014 may perform the cell reselection procedure 1028 when the UE 1014 is located in the area located within the first cell area 1004, the second cell arca 1006, and the third cell arca 1008.

The UE 1014 may utilize the information from the resource 1024 to select a cell on which to camp. For example, the UE 1014 may utilize the stored indication that the UE 1014 is to select the second frequency and the second cell for camping, if available. The UE 1014 may prioritize the resource indicated by the resource 1024. In the illustrated example, the UE 1014 may prioritize the second frequency and the second cell.

The UE 1014 may determine which cells are available for selection during the cell reselection procedure 1028. When the UE 1014 is located in the area located within the first cell area 1004, the second cell area 1006, and the third cell area 1008 in the illustrated example, the UE 1014 may determine that the first cell, the second cell, and the third cell are available. The UE 1014 may further determine signal quality of the available cells in some embodiments. Since the UE 1014 is performing reselection from the first cell (possibly based on the signal quality of the first cell being below a threshold quality), the UE 1014 may determine not to select the first cell. The UE 1014 may still have the opportunity to select the second cell or the third cell. Since the resource 1024 indicates that the second frequency and the second cell are to be prioritized, the UE 1014 may select the second cell on which to camp.

The second network element 1018 may transmit a broadcast message 1030. The second network element 1018 may broadcast the broadcast message 1030. The broadcast message 1030 may include an indication of a multicast configuration. The multicast configuration may indicate a configuration for the UE 1014 to receive multicast data for a multicast MBS session #X received from the second network element 1018 when the UE 1014 is in the inactive state.

The second network element 1018 (which corresponds to the second cell) may transmit a broadcast message 1030. The broadcast message 1030 may include an indication of an inactive multicast configuration to be utilized for processing multicast transmissions transmitted by the second network element 1018. Based on the UE 1014 selecting to camp on the second cell, the UE 1014 may receive and process the broadcast message 1030. Based on the broadcast message 1030, the UE 1014 may be configured with the inactive multicast configuration to process multicast transmissions transmitted by the second network element 1018.

The second network element 1018 may transmit multicast data 1032. The multicast data 1032 may correspond to an MBS session #X. The UE 1014 may receive the multicast data 1032 while the UE 1014 is in the inactive state. Further, the UE 1014 may utilize the inactive multicast configuration from the broadcast message 1030 to process the multicast data 1032. Accordingly, the UE 1014 may receive and process multicast data while in the inactive state, which was not available by legacy approaches.

While the signaling chart 1012 illustrates example signals that may be exchanged by UEs and network elements, it should be understood that additional signals may be included or some of the signals may be omitted in some embodiments. For example, the signals may be part of a larger procedure that includes additional signals.

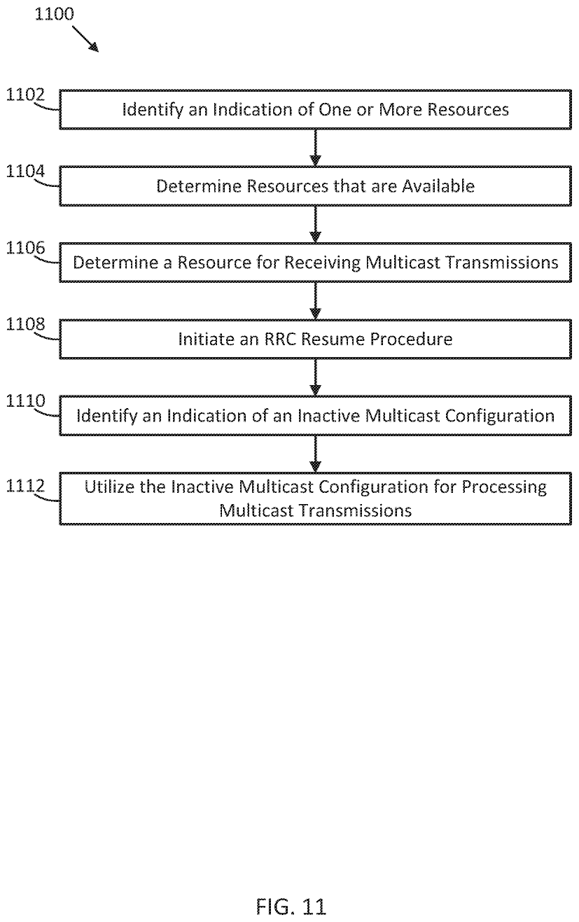

FIG. 11 illustrates an example procedure 1100 for determining resources for multicast transmissions in accordance with some embodiments. The procedure 1100 may be performed by a UE, such as the UE 414 (FIG. 4), the UE 514 (FIG. 5), the UE 614 (FIG. 6), the UE 714 (FIG. 7), the UE 814 (FIG. 8), the UE 914 (FIG. 9), the UE 1014 (FIG. 10), and/or the UE 1400 (FIG. 14). The UE may perform the procedure 1100 to determine one or more resources for receiving multicast transmissions.

The procedure 1100 may include identifying an indication of one or more resources in 1102. For example, the UE may identify an indication of one or more resources that can provide multicast service while the UE is in an inactive state. In some embodiments, the indication of the one or more resources may indicate a resource to which the UE is to be redirected.

In some embodiments, the indication of the one or more resources may comprise a list of cells that can provide multicast service while the UE is in the inactive state. For example, the list of cells may comprise any of the cell lists described throughout the disclosure. In some of these embodiments, the list of cells may comprise a list of cells per RRC state.

In some embodiments, the indication of the one or more resources may comprise a list of frequencies that can provide multicast service while the UE is in the inactive state. For example the list of frequencies may comprise any of the frequency lists described throughout the disclosure. In some of these embodiments, the list of frequencies may comprise a list of frequencies per MBS session.

The procedure 1100 may include determining resources that are available in 1104. For example, the UE may determine resources that are available for providing service to the UE. In embodiments where the indication of the one or more resources indicates a resource to which the UE is to be redirected, determining the resource for receiving the multicast transmission may comprise determining the resource to which the UE is to be redirected is the resource for receiving the multicast transmissions. In some embodiments, the resources that are available for providing service to the UE is determined as part of a handover from a first base station to a second base station.

The procedure 1100 may include determining a resource for receiving multicast transmissions in 1106. For example, the UE may determine a resource for receiving multicast transmissions based on the indication of the one or more resources and the resources that are available for providing multicast service to the UE. In some embodiments, determining the resource for receiving the multicast transmissions may comprise determining that the resources that are available for providing service to the UE do not include any of the one or more resources from the indication and determining the resource from the resources that are available for providing service to the UE.

The procedure 1100 may include initiating an RRC resume procedure in 1108. For example, the UE may initiate a RRC resume procedure for receiving the multicast transmissions. The UE may initiate the RRC resume procedure in embodiments where the resources that are available providing service to the UE do not include any of the one or more resources from the indication. In some embodiments, 1108 may be omitted. For example, 1108 may be omitted when the resource is included in the one or more resources from the indication.

The procedure 1100 may include identifying an indication of an inactive multicast configuration in 1110. For example, the UE may identify an indication of an inactive multicast configuration for receiving the multicast transmissions. In some embodiments, 1110 may be omitted.

The procedure 1100 may include utilizing the inactive multicast configuration for processing multicast transmissions in 1112. For example, the UE may utilize the inactive multicast configuration for processing the multicast transmissions received by the UE. In some embodiments, 1112 may be omitted.

While an order of operations for the procedure 1100 may be applied by FIG. 11, it should be understood that the order of operations may be different and/or one or more of the operations may be performed concurrently in other embodiments. Further, it should be understood that one or more of the operations may be omitted and/or one or more additional operations may be included in other embodiments.

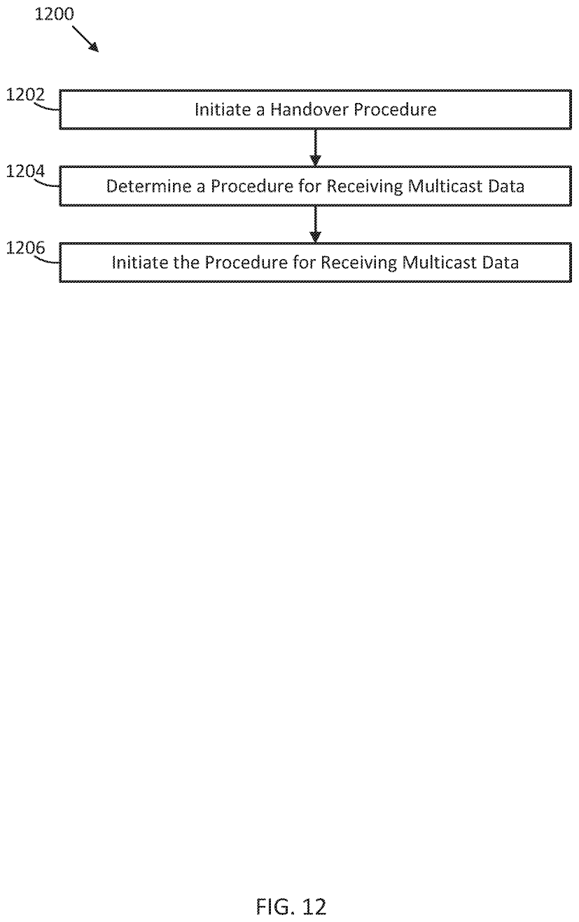

FIG. 12 illustrates another example procedure 1200 for determining resources for multicast transmissions in accordance with some embodiments. The procedure 1200 may be performed by a UE, such as the UE 414 (FIG. 4), the UE 514 (FIG. 5), the UE 614 (FIG. 6), the UE 714 (FIG. 7), the UE 814 (FIG. 8), the UE 914 (FIG. 9), the UE 1014 (FIG. 10), and/or the UE 1400 (FIG. 14). The UE may perform the procedure 1200 to determine one or more resources for receiving multicast transmissions.

The procedure 1200 may include initiating a handover procedure in 1202. For example, the UE may initiate a handover procedure from a first cell to a second cell while the UE is in an inactive state.

The procedure 1200 may include determining a procedure for receiving multicast data in 1204. For example, the UE may determine, based on an indication of one or more resources that can provide multicast service, a procedure for receiving multicast service from the second cell. The indication of the one or more resources may be received from the first cell. In some embodiments, the indication of the one or more resources may comprise an indication of one or more cells that can provide multicast service while the UE is in the inactive state. Further, the indication of the one or more resources may comprise an indication of one or more frequencies that can provide multicast service while the UE is in the inactive state in some embodiments. In some embodiments, the procedure may further be determined based on an indication of a prioritized state for the UE when receiving multicast data from the second cell, the indication of the prioritized state being received from the first cell.

In some embodiments, the indication of the one or more resources may comprise an indication of one or more resources that can provide multicast service while the UE is in the inactive state. In these embodiments, determining the procedure for receiving multicast data may comprise determining to implement an inactive multicast configuration for processing multicast data received.

In some embodiments, the indication of the one or more resources may not include a resource corresponding to the second cell. In some of these embodiments, determining the procedure for receiving multicast data comprises determining an RRC resume procedure for receiving multicast data based on the resource corresponding to the second cell not being included in the indication of the one or more resources.

In some embodiments, the indication of the one or more resources comprise an indication that the UE is to be in a connected state when receiving multicast data when receiving multicast data from the second cell. In some of these embodiments, determining the procedure may comprise determining an RRC resume procedure for receiving multicast data based on the indication that the UE is to be in a connected state when receiving multicast data from the second cell.

The procedure 1200 may include initiating the procedure for receiving multicast data in 1206. For example, the UE may initiate the procedure determined in 1204 for processing multicast data received from the second cell.

In some embodiments, initiating the procedure may comprise implementing the inactive multicast configuration for processing the multicast data received from the second cell. For example, the inactive multicast configuration may be implemented where it has been determined to implement the inactive multicast configuration in 1204.

In some embodiment, initiating the procedure may comprise initiating the RRC resume procedure for processing the multicast data. For example, the RRC resume procedure may be initiated where it has been determined to utilize the RRC resume procedure in 1204.

The procedure 1200 refers to a first cell and a second cell. It should be understood that the first cell and the second cell should be interpreted in accordance with this disclosure. For example, the first cell may be serviced by a first base station and the second cell may be serviced by a second base station. Accordingly, it should be understood that communications related to the first cell may be communicated via the first base station and communications related to the second cell may be communication via the second base station. In other embodiments, a base station may service more than one cell, where both the first cell and the second cell are serviced by the same base station.

While an order of operations for the procedure 1200 may be applied by FIG. 12, it should be understood that the order of operations may be different and/or one or more of the operations may be performed concurrently in other embodiments. Further, it should be understood that one or more of the operations may be omitted and/or one or more additional operations may be included in other embodiments.

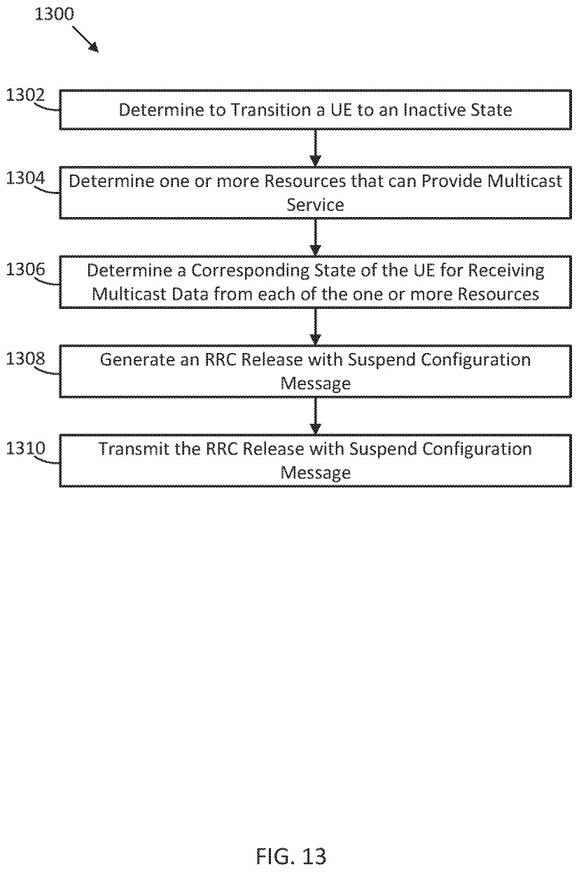

FIG. 13 illustrates an example procedure 1300 for indicating resources for multicast transmissions in accordance with some embodiments. The procedure 1300 may be performed by a base station, such as the first network clement 416 (FIG. 4), the second network element 418 (FIG. 4), the first network element 516 (FIG. 5), the second network clement 518 (FIG. 5), the first network element 616 (FIG. 6), the second network element 618 (FIG. 6), the first network element 716 (FIG. 7), the second network element 718 (FIG. 7), the first network clement 816 (FIG. 8), the second network element 818 (FIG. 8), the first network clement 916 (FIG. 9), the second network clement 918 (FIG. 9), the first network clement 1016 (FIG. 10), the second network element 1018 (FIG. 10), and/or the gNB 1500 (FIG. 15). The network element may perform the procedure 1300 to indicate one or more resources for receiving multicast transmissions.

The procedure 1300 may include determining to transition a UE to an inactive state in 1302. For example, the base station may determine to transition a UE coupled to the base station to an inactive state.

The procedure 1300 may include determining one or more resources that can provide multicast service in 1304. For example, the base station may determine one or more resources that can provide multicast service to the UE. In some embodiments, determining the one or more resources may comprise determining one or more cells that can provide multicast service for the UE while the UE is in the inactive state. Further, determining the one or more resources may comprise determining one or more frequencies that can provide multicast service for the UE while the UE is the inactive state.

The procedure 1300 may include determining a corresponding state of the UE for receiving multicast data from each of the one or more resources in 1306. For example, the base station may determine a corresponding state of the UE for receiving multicast data from each of the one or more resources. In some embodiments, 1306 may be omitted.

The procedure 1300 may include generating an RRC release with suspend configuration message in 1308. For example, the base station may generate an RRC release with suspend configuration message that includes an indication of the one or more resources. The RRC release with suspend configuration message may include one or more of the features of the RRC release with suspend configuration messages described throughout this disclosure. In some embodiments, the RRC release with suspend configuration message may further include an indication of the corresponding state of the UE for receiving multicast data from each of the one or more resources.

The procedure 1300 may include transmitting the RRC release with suspend configuration message in 1310. For example, the base station may transmit the RRC release with suspend configuration message to the UE to cause the UE to transition to the inactive state.

While an order of operations for the procedure 1300 may be applied by FIG. 13, it should be understood that the order of operations may be different and/or one or more of the operations may be performed concurrently in other embodiments. Further, it should be understood that one or more of the operations may be omitted and/or one or more additional operations may be included in other embodiments.

FIG. 14 illustrates an example UE 1400 in accordance with some embodiments. The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1400 may be a RedCap UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, phased array antennas, etc. The antenna 1426 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

FIG. 15 illustrates an example gNB 1500 in accordance with some embodiments. The gNB 1500 may include processors 1504, RF interface circuitry 1508, core network (CN) interface circuitry 1512, memory/storage circuitry 1516, and antenna structure 1526.

The components of the gNB 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE), comprising identifying an indication of one or more resources that can provide multicast service while the UE is in an inactive state, determining resources that are available for providing service to the UE, and determining a resource for receiving multicast transmissions based on the indication of the one or more resources and the resources that are available for providing multicast service to the UE.

Example 2 may include the method of example 1, wherein the indication of the one or more resources comprises a list of cells that can provide multicast service while the UE is in the inactive state.

Example 3 may include the method of example 2, wherein the list of cells comprises a list of cells per radio resource control (RRC) state.

Example 4 may include the method of example 1, wherein the indication of the one or more resources comprises a list of frequencies that can provide multicast service while the UE is in the inactive state.

Example 5 may include the method of example 4, wherein the list of frequencies comprises a list of frequencies per multicast/broadcast service (MBS) session.

Example 6 may include the method of example 1, wherein the indication of the one or more resources indicates a resource to which the UE is to be redirected, wherein determining the resource for receiving the multicast transmissions comprises determining the resource to which the UE is to be redirected is the resource for receiving the multicast transmissions.

Example 7 may include the method of example 1, wherein determining the resource for receiving the multicast transmissions comprises determining that the resources that are available for providing service to the UE do not include any of the one or more resources from the indication, and determining the resource from the resources that are available for providing service to the UE, and the method further comprises initiating a radio resource control (RRC) resume procedure for receiving the multicast transmissions.

Example 8 may include the method of example 1, further comprising identifying an indication of an inactive multicast configuration for receiving the multicast transmissions, and utilizing the inactive multicast configuration for processing the multicast transmissions received by the UE.

Example 9 may include the method of example 1, wherein the resources that are available for providing service to the UE is determined as part of a handover from a first base station to a second base station.

Example 10 may include a method of operating a user equipment (UE), comprising initiating a handover procedure from a first cell to a second cell while the UE is in an inactive state, determining, based on an indication of one or more resources that can provide multicast service, a procedure for receiving multicast data from the second cell, the indication of the one or more resources being received from the first cell, and initiating the procedure for processing multicast data received from the second cell.

Example 11 may include the method of example 10, wherein the indication of the one or more resources comprises an indication of one or more resources that can provide multicast service while the UE is in the inactive state, wherein determining the procedure for receiving multicast data comprises determining to implement an inactive multicast configuration for processing multicast data received, and wherein initiating the procedure comprises implement the inactive multicast configuration for processing the multicast data received from the second cell.

Example 12 may include the method of example 10, wherein the indication of the one or more resources does not include a resource corresponding to the second cell, wherein determining the procedure for receiving multicast data comprises determining a radio resource control (RRC) resume procedure for receiving multicast data based on the resource corresponding to the second cell not being included in the indication of the one or more resources, and wherein initiating the procedure comprises initiating the RRC resume procedure for processing the multicast data received from the second cell.

Example 13 may include the method of example 10, wherein the indication of the one or more resources comprises an indication that the UE is to be in a connected state when receiving multicast data from the second cell, wherein determining the procedure comprises determining a radio resource control (RRC) resume procedure for receiving multicast data based on the indication that the UE is to be in a connected state when receiving multicast data from the second cell, and wherein initiating the procedure comprises initiating the RRC resume procedure for processing the multicast data received from the second cell.

Example 14 may include the method of example 10, wherein the indication of the one or more resources comprises an indication of one or more cells that can provide multicast service while the UE is in the inactive state.

Example 15 may include the method of example 10, wherein the indication of the one or more resources comprises an indication of one or more frequencies that can provide multicast service while the UE is in the inactive state.

Example 16 may include the method of example 10, wherein the procedure is further determined based on an indication of a prioritized state for the UE when receiving multicast data from the second cell, the indication of the prioritized state being received from the first cell.

Example 17 may include a method of operating a base station, comprising determining to transition a user equipment (UE) coupled to the base station to an inactive state, determining one or more resources that can provide multicast service for the UE. generating a radio resource control (RRC) release with suspend configuration message that includes an indication of the one or more resources, and transmitting the RRC release with suspend configuration message to the UE to cause the UE to transition to the inactive state.

Example 18 may include the method of example 17, wherein determining the one or more resources comprises determining one or more cells that can provide multicast service for the UE while the UE is in the inactive state.

Example 19 may include the method of example 17, wherein determining the one or more resources comprises determining one or more frequencies that can provide multicast service for the UE while the UE is in the inactive state.

Example 20 may include the method of example 17, further comprising determining a corresponding state of the UE for receiving multicast data from each of the one or more resources, wherein the RRC release with suspend configuration message further includes an indication of the corresponding state of the UE for receiving multicast data from each of the one or more resources.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory computer-readable media having instructions stored thereon, wherein the instructions, when executed, cause processing circuitry to:
identify an indication, received from a base station, of a list of cells that provide a multicast/broadcast service (MBS) for an inactive state;
identify a cell for a service based at least in part on the list of cells; and
receive the service from the cell.

22. The one or more non-transitory computer-readable media of claim 21, wherein the instructions, when executed, further cause the processing circuitry to:
perform a radio resource control (RRC) resume operation for the cell based at least in part on the cell not being included in the list of cells.

23. The one or more non-transitory computer-readable media of claim 21, wherein the instructions, when executed, further cause the processing circuitry to:
perform a radio resource control (RRC) resume operation for the cell based at least in part on the list of cells excluding a cell that provides the service.

24. The one or more non-transitory computer-readable media of claim 21, wherein to identify the cell includes to identify the cell from one or more cells in the list of cells.

25. The one or more non-transitory computer-readable media of claim 21, wherein to identify the cell includes to prioritize selection of the cell for a cell reselection procedure based at least in part on the cell being included in the list of cells.

26. The one or more non-transitory computer-readable media of claim 21, wherein to identify the cell includes to identify the cell for a cell reselection procedure.

27. The one or more non-transitory computer-readable media of claim 21, wherein the list of cells is associated with point-to-multipoint (PTM) or point-to-point (PTP) links.

28. The one or more non-transitory computer-readable media of claim 21, wherein the list of cells is a first list of cells, and wherein the instructions, when executed, further cause the processing circuitry to:
identify an indication, received from the base station, of a second list of cells for that provide the MBS for a connected state.

29. The one or more non-transitory computer-readable media of claim 21, wherein the indication of the list of cells is identified in a radio resource control (RRC) release configuration message.

30. A method comprising:
identifying an indication of a list of cells that provide a multicast/broadcast service (MBS) for an inactive state, the indication received from a base station; and
identifying a cell for a service based at least in part on the list of cells.

31. The method of claim 30, further comprising:
performing a radio resource control (RRC) resume operation for the cell based at least in part on the cell not being included in the list of cells.

32. The method of claim 30, further comprising:
identifying that the cell does not provide the service in the inactive state based at least in part on the list of cells; and
performing a radio resource control (RRC) resume operation for the cell based at least in part on the identification does not provide the service in the inactive state.

33. The method of claim 30, wherein identifying the cell includes prioritizing selection of the cell for a cell reselection procedure based at least in part on the cell being within the list of cells.

34. The method of claim 30, wherein the list of cells is associated with point-to-multipoint (PTM) or point-to-point (PTP) links.

35. The method of claim 30, wherein the indication of the list of cells is identified in a radio resource control (RRC) release configuration message.

36. The method of claim 30, wherein the list of cells is a first list of cells, and wherein the method further comprises:
identifying an indication of a second list of cells that provide the MBS in a connected state, the indication of the second list of cells received from the base station.

37. An apparatus comprising:
processing circuitry to:
identify one or more cells that are to provide a multicast/broadcast service (MBS); and
generate an indication of a list of the one or more cells for transmission to a user equipment (UE); and
interface circuitry coupled with the processing circuitry, the interface circuitry to enable communication.

38. The apparatus of claim 37, wherein the one or more cells are to provide the MBS in an inactive state.

39. The apparatus of claim 37, wherein the processing circuitry is further to:
generate a radio resource control (RRC) release configuration message for transmission to the UE, wherein the RRC release configuration message includes the indication of the list of the one or more cells.

40. The apparatus of claim 37, wherein the one or more cells are first one or more cells, wherein the one or more cells are to provide the MBS in an inactive state, and wherein the processing circuitry is further to:
identify second one or more cells available for the MBS in a connected state; and
generate an indication of a second list of cells for transmission to the UE, the second list of cells including the second one or more cells.
